(19) United States
(12) Patent Application Publication
(10) Pub. No.: US 2015/0214529 A1
(43) Pub. Date: Jul. 30, 2015

(54) NON-AQUEOUS ELECTROLYTIC SOLUTION SECONDARY BATTERY

(71) Applicant: FUJIFILM CORPORATION, Tokyo (JP)

(72) Inventors: Toshihiko YAWATA, Kanagawa (JP); Ikuo KINOSHITA, Kanagawa (JP)

(73) Assignee: FUJIFILM CORPORATION, Tokyo (JP)

(21) Appl. No.: 14/683,472

(22) Filed: Apr. 10, 2015

Related U.S. Application Data
(63) Continuation of application No. PCT/JP2013/077128, filed on Oct. 4, 2013.

(30) Foreign Application Priority Data
Oct. 11, 2012 (JP) 2012-226052

(51) Int. Cl. H01M 2/16; H01M 4/13; H01M 10/0567

(52) U.S. Cl. CPC H01M 2/1686; H01M 10/0567; H01M 2/1653; H01M 2/1606; H01M 2/1646; H01M 4/13; H01M 2300/0025

(57) ABSTRACT

A non-aqueous electrolytic solution secondary battery includes: a positive electrode; a negative electrode; a separator that separates the positive electrode and the negative electrode from each other; and an electrolytic solution that is introduced into the non-aqueous electrolytic solution secondary battery so as to come into contact with the positive electrode and the negative electrode with the separator interposed therebetween, wherein the electrolytic solution contains an electrolyte and a phosphazene compound in an aprotic solvent, and the separator is a complex that is composed of a substrate containing a non-heat-resistant resin and a heat-resistant material coating the substrate.

### CROSS-REFERENCE TO RELATED APPLICATIONS

This application is a Continuation of PCT International Application No. PCT/JP2013/077128 filed on Oct. 4, 2013, which claims priority under 35 U.S.C §119(a) to Japanese Patent Application No. 2012-226052 filed on Oct. 11, 2012. Each of the above application(s) is hereby expressly incorporated by reference, in its entirety, into the present application.

### BACKGROUND OF THE INVENTION

1. Field of the Invention

The present invention relates to a non-aqueous electrolytic solution secondary battery.

2. Description of the Related Art

Portable electronic apparatuses are essential tools for today's social life or business. As these portable electronic apparatuses have been further developed and diversified, the performance of batteries as a power supply thereof has increasingly attracted attention. In order to satisfy the needs, it is necessary to decrease the size and weight and to increase the capacity in the power supply. In addition, the stability, reliability, and safety of the batteries are also required.

On the other hand, a lithium ion secondary battery realizes a high operating voltage of 3 V to 4 V as compared to an aqueous solution battery having an operating voltage of about 1.2 V. In addition, the lithium secondary battery has superior lightweight properties. Further, the lithium secondary battery has no memory effect in a nickel-cadmium storage battery or a nickel-metal hydride storage battery and can stably supply energy. Due to these characteristics, the lithium secondary battery is rapidly increasing in market share to be mainly used in a mobile phone or a laptop computer instead of other secondary batteries. Recently, the use range of the lithium secondary battery has been widened to include an electric-assisted bicycle, an electric tool, a hybrid vehicle, an electric vehicle, a robot, a spaceship, and an airplane, and further development thereof is expected.

In consideration of the above-described circumstances, the battery capacity is also strongly desired to be improved, and the battery capacity of a commercially available product has been increasing. Hitherto, the battery capacity of the lithium secondary battery has been improved by measures, for example, an increase in the packing density of an active material, an increase in charging voltage to increase a positive electrode utilization rate, an increase in the graphitization degree of a negative electrode, or a decrease in the size of a separator or a current collector. However, an increase in capacity using the above-described method is approaching the limit. In particular, along with an increase in capacity, a safety countermeasure has become important.

In order to improve flame retardancy, an electrolytic solution has been improved in various ways. Representative examples of the improvement include techniques in which an electrolytic solution contains cyclophosphazene or a phosphate compound (refer to WO2002/082575A, JP2011-108649A, and JP2012-134151A).

### SUMMARY OF THE INVENTION

A phosphate compound and a phosphazene compound has an effect of imparting flame retardancy, and a technique of adding a phosphazene compound to an electrolytic solution is extremely useful to improve the safety and reliability of a lithium secondary battery. In anticipation of further improvement of the technique, the present inventors have focused on a combination of a phosphazene compound, which is selected among the flame retardants, with a separator which is an important component from the viewpoint of the safety of a secondary battery.

The present invention has been made to provide a non-aqueous electrolytic solution secondary battery, capable of further improving flame retardancy while securing battery performance by using an electrolytic solution containing a specific flame retardant in combination with a specific separator.

The above-described problems are solved by the following means.

[1] A non-aqueous electrolytic solution secondary battery including:

a positive electrode;

a negative electrode;

a separator disposed between the positive electrode and the negative electrode from each other; and

an electrolytic solution that is in contact with the positive electrode and the negative electrode through the separator,

wherein the electrolytic solution contains an electrolyte, a phosphazene compound, and an aprotic solvent, and

the separator is a complex that is composed of a substrate containing a non-heat-resistant resin and a heat-resistant material coating the substrate.

[2] The non-aqueous electrolytic solution secondary battery according to [1],

wherein the substrate is a resin microporous film.

[3] The non-aqueous electrolytic solution secondary battery according to [1] or [2],

wherein a heat-resistant resin is used as the heat-resistant material, and a difference (ΔTg=Tg2−Tg1) between a glass transition point (Tg1) of a resin constituting the substrate and a glass transition point (Tg2) of the heat-resistant resin is 30° C. to 250° C.

[4] The non-aqueous electrolytic solution secondary battery according to any one of [1] to [3],

wherein the heat-resistant resin is selected from a polyamide resin, a polyimide resin, polyacrylonitrile, polyethylene terephthalate, polyfluoroethylene and polymethylpentene.

[5] The non-aqueous electrolytic solution secondary battery according to any one of [1] to [4],

wherein the heat-resistant material is fibrous or particulate.

[6] The non-aqueous electrolytic solution secondary battery according to any one of [1] to [5],

wherein alumina or silica is used as the heat-resistant material.

[7] The non-aqueous electrolytic solution secondary battery according to any one of [1] to [6],

wherein the non-heat-resistant resin is polyethylene or polypropylene.

[8] The non-aqueous electrolytic solution secondary battery according to any one of [1] to [7],

wherein the substrate of the separator is a microporous film containing polyethylene or polypropylene, and

the heat-resistant material coating the substrate is selected from a polyamide resin, a polyimide resin, polyacrylonitrile, polyethylene terephthalate, and polymethylpentene.

[9] The non-aqueous electrolytic solution secondary battery according to any one of [1] to [8],

wherein the phosphazene compound is represented by the following formula (1),

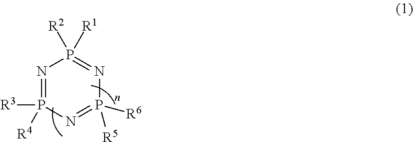

wherein R¹ to R⁶ each independently represents a monovalent substituent, and n represents an integer of 1 or more.

[10] The non-aqueous electrolytic solution secondary battery according to any one of [1] to [9],

wherein the positive electrode is an electrode containing manganese.

[11] The non-aqueous electrolytic solution secondary battery according to any one of [1] to [10],

wherein the substrate of the separator has a thickness of 2 μm to 50 μm.

[12] The non-aqueous electrolytic solution secondary battery according to any one of [1] to [11],

wherein a coating layer formed by using the heat-resistant material has a thickness of 2 μm to 30 μm.

In this specification, when plural substituents or the number of substituents is defined at the same time, the substituents may be different from each other. In addition, adjacent substituents may be linked or condensed to form a ring.

A non-aqueous electrolytic solution secondary battery according to the present invention can further improve flame retardancy while securing battery performance by using an electrolytic solution containing a specific flame retardant in combination with a specific separator.

The above-described and other characteristics and advantageous effects of the present invention will be clarified from the following description and the accompanying drawings.

### BRIEF DESCRIPTION OF THE DRAWINGS

FIG. 1 is a cross-sectional view schematically showing a mechanism of a lithium secondary battery according to a preferred embodiment of the present invention.

FIG. 2 is a cross-sectional view showing a specific mechanism of the lithium secondary battery according to the preferred embodiment of the present invention.

### DESCRIPTION OF THE PREFERRED EMBODIMENTS

Hereinafter, the present invention will be described in detail based on preferred embodiments thereof.

(Phosphazene Compound)

A phosphazene compound which is preferably adopted in the present invention refers to a group of compounds having a double bond which contain phosphorus and nitrogen as a constituent element. Among these compounds, a cyclophosphazene compound is preferable, and a compound represented by the following formula (1) is more preferable.

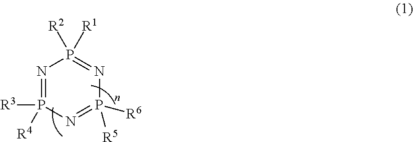

R¹ to R⁶

In the formula, R¹ to R⁶ each independently represents a monovalent substituent. The monovalent sub stituent is preferably an alkyl group, an aryl group, an alkoxy group, an aryloxy group, or a specific nitrogen-containing group (described below) such as an amino group, or a halogen atom such as a fluorine atom, a chlorine atom, or a bromine atom. It is preferable that at least one of substituents of R¹ to R⁶ is a fluorine atom. The alkyl group is preferably an alkyl group having preferably 1 to 8 carbon atoms, more preferably 1 to 6 carbon atoms, or still more preferably 1 to 4 carbon atoms that may be substituted, an aryl group having preferably 6 to 12 carbon atoms or more preferably 6 to 8 carbon atoms that may be substituted, an alkoxy group having preferably 1 to 8 carbon atoms, more preferably 1 to 6 carbon atoms, or still more preferably 1 to 4 carbon atoms that may be substituted, an aryloxy group having preferably 6 to 12 carbon atoms or more preferably 6 to 8 carbon atoms that may be substituted, a specific nitrogen-containing group such as an amino group having 1 to 12 carbon atoms, a fluorine atom, or a chlorine atom.

Among these, an alkyl group, an alkoxy group, a specific nitrogen-containing group, a fluorine atom, or a chlorine atom is preferable, and three or more fluorine atoms are more preferable.

The substituents are preferably composed of an alkoxy group, a specific nitrogen-containing group, and a fluorine atom, and are still more preferably composed of a specific nitrogen-containing group and a fluorine atom.

Among the substituents of R¹ to R⁶, at least one is preferably —NR^{A}R^{B},—N═R^{C}or an azide group, and at least another one is preferably a halogen atom. Among these, it is preferable that all the substituents of R¹ to R⁶ are composed of combinations of a halogen atom with a group or a combination (hereinafter, also referred to as “specific nitrogen-containing group”) selected from —NR^{A}R^{B}, —N═R^{C}, and an azide group. As the halogen atom, a fluorine atom is preferable. The number of the specific nitrogen-containing groups is not particularly limited, but is preferably 1 to 4, more preferably 1 to 3, still more preferably 1 or 2, and even still more preferably 1. Regarding a substitution site, it is preferable that one specific nitrogen-containing group is substituted with one phosphorus atom.

Among R¹ to R⁶, adjacent substituents may be linked to form a ring containing a phosphorus atom. R¹ to R⁶ may be the same as or different from one another. Particularly when a ring is formed, it is preferable that R¹ and R², R³ and R⁴, or R⁵ and R⁶ form the ring.

n

n represents an integer of 1 or more, preferably 1 to 3, more preferably 1 or 2, and still more preferably 1. When n is 2 or more, R⁵ and R⁶ may be different from each other.

R^{A}, R^{B}

R^{A} and R^{B} each independently represents a hydrogen atom, an alkyl group, an aryl group, an alkenyl group, an alkynyl group, a heterocyclic group, a cyano group, a silyl group, or a substituent represented by the following formula (1A), (1B), (1C) or (1D).

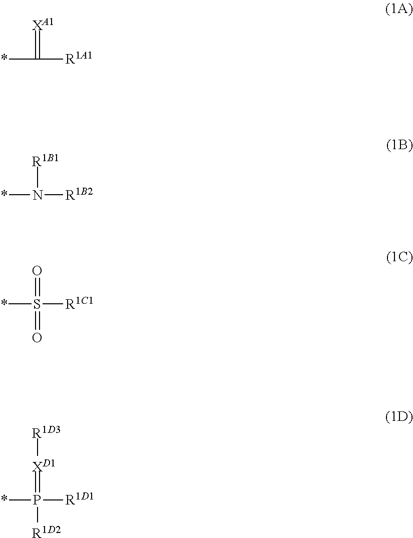

R^{A} and R^{B} each independently represents preferably an alkyl group, an aryl group, or a substituent represented by the formula (1A) or (1D); more preferably an alkyl group having 1 to 6 carbon atoms, a fluorine-substituted alkyl group having 1 to 6 carbon atoms, an alkyl group having 1 to 6 carbon atoms that contains an ether group, an aryl group having 6 to 12 carbon atoms, or a substituent having 1 to 7 carbon atoms represented by the formula (1A); and still more preferably an alkyl group having 1 to 4 carbon atoms or a fluorine-substituted alkyl group having 1 to 4 carbon atoms. In this case, the total number of carbon atoms in the substituent is preferably 6 or less and more preferably 4 or less. R^{A} and R^{B} may be linked or condensed to form a ring containing a nitrogen atom. The alkyl group may be linear or branched. R^{A} and R^{B} may be the same as or different from each other.

R^{1A1}, R^{1C1}, R^{1D1}, R^{1D2}

In the formula, R^{1A1}, R^{1C1}, R^{1D1, and R}^{1D2} each independently represents an alkyl group, an alkoxy group, an aryl group, an aryloxy group, a halogen atom, or an amino group. Preferable examples of the substituents are as follows. That is, R^{1A1}, R^{1C1}, R^{1D1}, and R^{1D2} each independently represents preferably an alkyl group having 1 to 6 carbon atoms, an alkoxy group having 1 to 6 carbon atoms, an aryl group having 6 to 12 carbon atoms, an aryloxy group having 6 to 12 carbon atoms, chlorine atoms, or a fluorine atom; and more preferably an alkyl group having 1 to 6 carbon atoms, an alkoxy group having 1 to 6 carbon atoms, a chlorine atom, or a fluorine atom. These substituents may be further substituted. * represents a direct bond.

R^{1B1}, R^{1B2}

R^{1B1} and R^{1B2} each independently represents a hydrogen atom, an alkyl group, an aryl group, an alkoxycarbonyl group, an aryloxycarbonyl group, an alkylsulfonyl group, an arylsulfonyl group, a silyl group, or a phosphonyl group. Preferable examples of the substituents are as follows. That is, R^{1B1} and R^{1B2} each independently represents preferably an alkyl group having 1 to 6 carbon atoms, an alkoxycarbonyl group having 1 to 7 carbon atoms, an aryl group having 6 to 12 carbon atoms, an aryloxycarbonyl group having 7 to 12 carbon atoms, an alkylsulfonyl group having 1 to 6 carbon atoms, an arylsulfonyl group having 6 to 12 carbon atoms, a silyl group having 1 to 6 carbon atoms, or a phosphonyl group having 1 to 12 carbon atoms; and more preferably an alkyl group having 1 to 6 carbon atoms, an alkoxycarbonyl group having 1 to 7 carbon atoms, an alkylsulfonyl group having 1 to 6 carbon atoms, a silyl group having 1 to 6 carbon atoms, or a phosphonyl group having 1 to 12 carbon atoms.

X^{A1}, X^{D1}, R^{1D3}

In the formula, X^{A1} represents an oxygen atom or a sulfur atom.

X^{D1} represents an oxygen atom, a sulfur atom, or a nitrogen atom. When X^{D1} represents an oxygen atom or a sulfur atom, R^{1D3} is not a substituent. When X^{D1} represents a nitrogen atom, R^{1D3} represents an alkyl group (having preferably 1 to 8 carbon atoms), an aryl group (having preferably 6 to 12 carbon atoms), a silyl group (having preferably 1 to 21 carbon atoms), or a phosphonyl group (having preferably 1 to 18 carbon atoms).

Rc

Rc represents a substituent represented by any one of the following formulae (C1) to (C6).

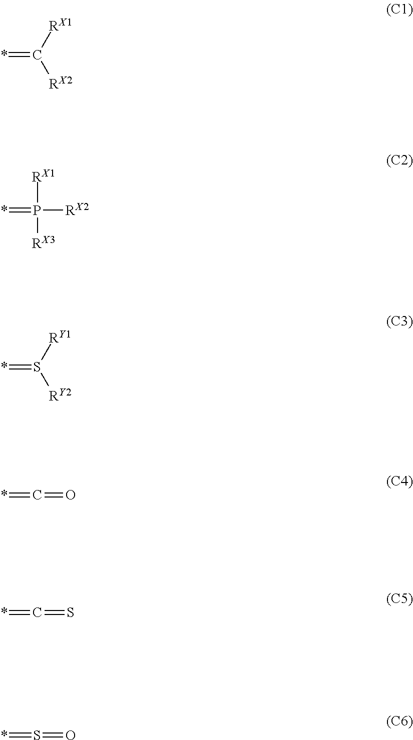

R^{X1}, R^{X2}, and R^{X3} each independently represents an alkyl group, an aryl group, an alkoxy group, an aryloxy group, an alkylthio group, an arylthio group, a heterocyclic group, a halogen atom, or a silyl group. R^{X1}, R^{X2}, and R^{X3} each independently represents preferably an alkyl group having 1 to 6 carbon atoms, an alkoxy group having 1 to 6 carbon atoms, an alkylthio group having 1 to 6 carbon atoms, a chlorine atom, a fluorine atom, or a silyl group having 1 to 15 carbon atoms. R^{Y1} and R^{Y2} each independently represents a halogen atom.

The kind and number of substituents of R¹ to R⁶ are not particularly limited. However, from the viewpoint of securing flame retardancy while maintaining battery performance, it is preferable that two or more of all the substituents are fluorine atoms; and that the remaining substituents are the specific nitrogen-containing groups and alkoxy groups. It is more preferable that three or more of all the substituents are fluorine atoms. It is most preferable that four or more of all the substituents are fluorine atoms. Alternatively, from the same point as above, it is preferable that all the substituents of R¹ to R⁶ are composed of a halogen atom (preferably a fluorine atom) and the specific nitrogen-containing group. It is preferable that 1 to 3 of all the substituents are the specific nitrogen-containing groups, it is more preferable that one or two of all the substituents are the specific nitrogen-containing groups, and it is still more preferable that one of all the substituents is the specific nitrogen-containing group.

It is preferable that the compound represented by the formula (1) is a compound represented by the following formula (1A) or (1B).

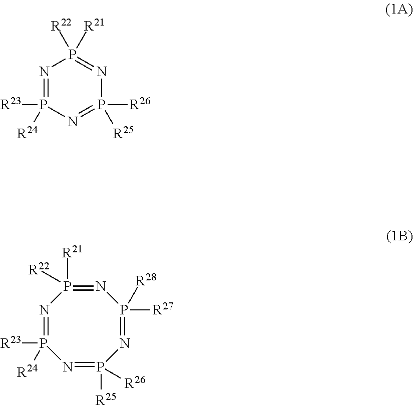

R²¹ to R²⁸

In the formula, R²¹ to R²⁸ have the same definition as that of R1 to R6 in the formula (1). R²¹ to R²⁸ each independently represents preferably a halogen atom, an alkyl group, an aryl group, an alkoxy group, an aryloxy group, a thioalkyl group, a thioaryl group, or the specific nitrogen-containing group. An alkyl group having 1 to 6 carbon atoms, an aryl group having 6 to 12 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, a halogen atom (preferably, a chlorine atom or a fluorine atom), or the specific nitrogen-containing group is more preferable. The specific nitrogen-containing group, a fluorine atom, an alkyl group having 1 to 6 carbon atoms, or an alkoxy group having 1 to 6 carbon atoms is still more preferable. The alkyl group and the aryl group may be substituted. The alkyl group may be linear or branched. Among the substituents of R²¹ to R²⁸, at least one is preferably —NR^{A}R^{B}, —N═R^{C}, an azide group, or a combination (specific nitrogen-containing group), and at least another one is preferably a fluorine atom. It is more preferable that the substituents are compounds composed of the specific nitrogen-containing group and a fluorine atom. It is preferable that the number of the specific nitrogen-containing groups is 1 to 4, preferably 1 to 3, more preferably 1 or 2, and still more preferably 1; and that all the substituents other than the specific nitrogen-containing group are fluorine atoms.

Hereinafter, specific examples of the compound represented by the formula (1) will be shown below but are not intended to limit the present invention.

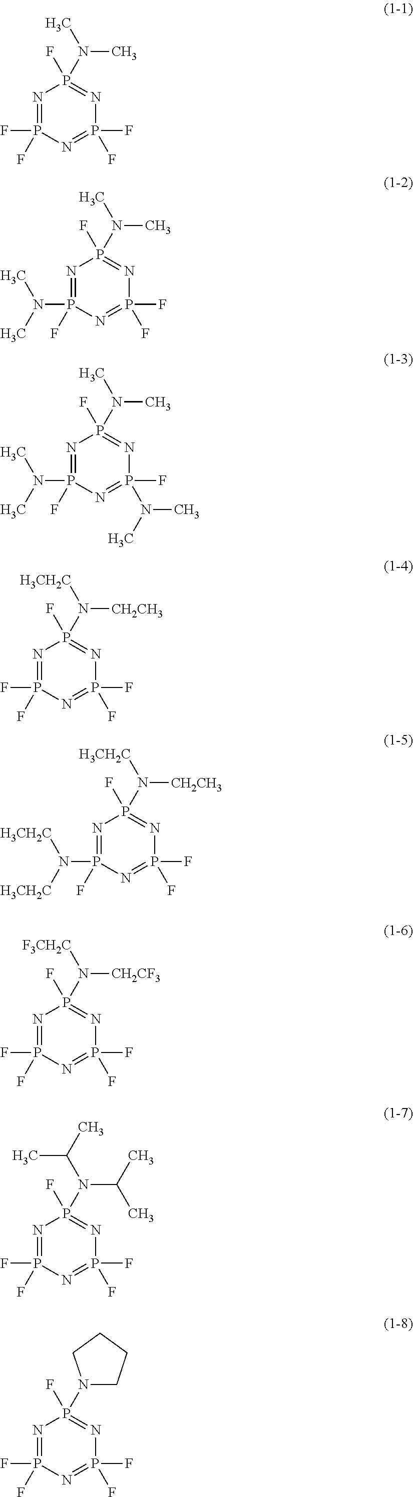

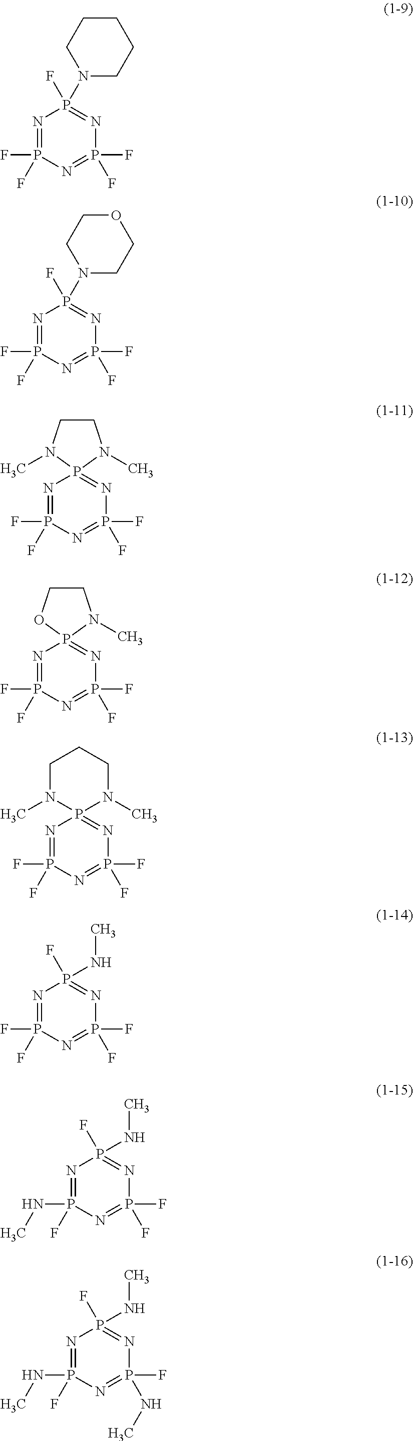

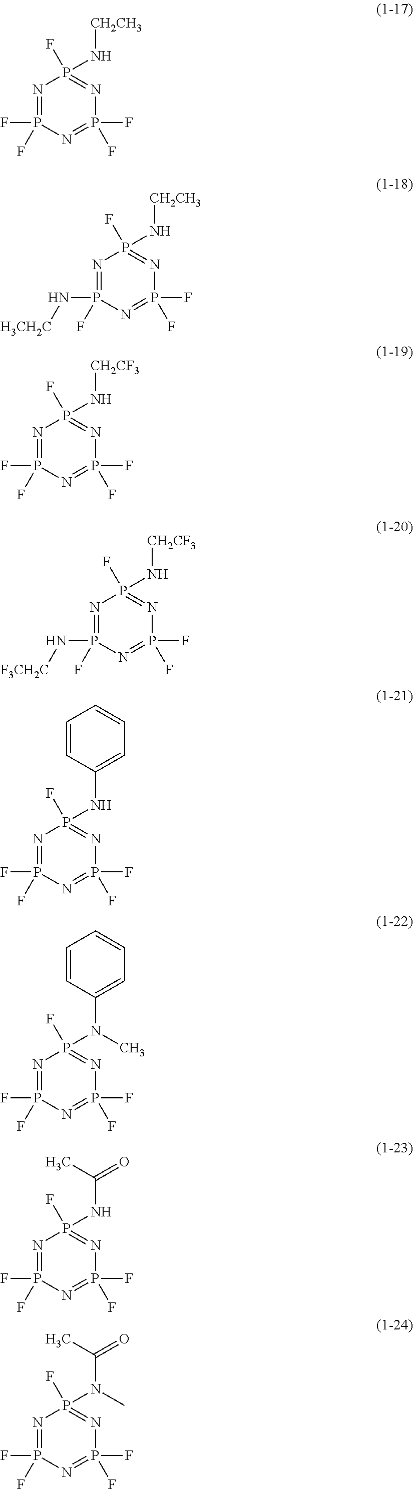

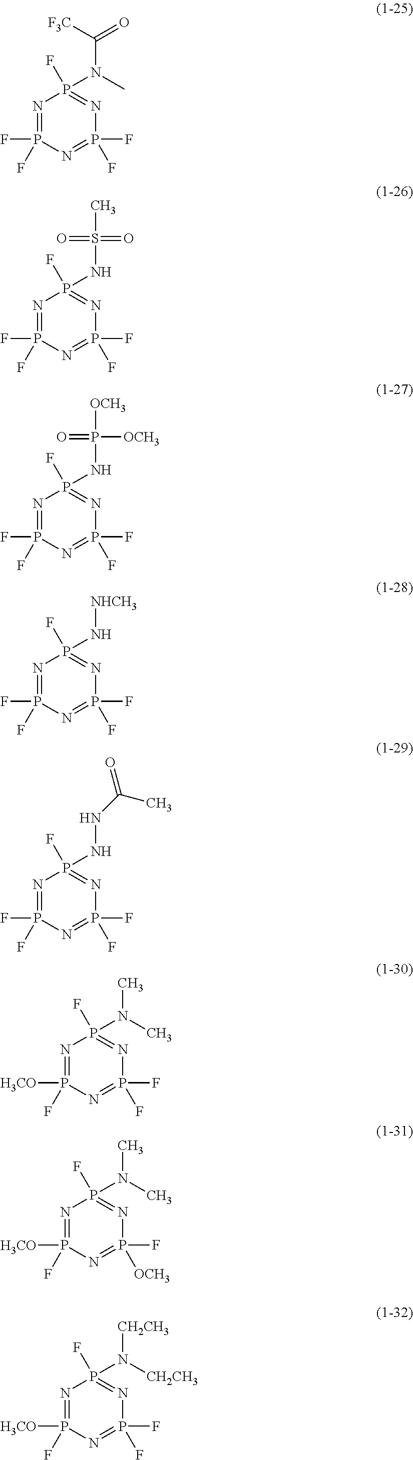

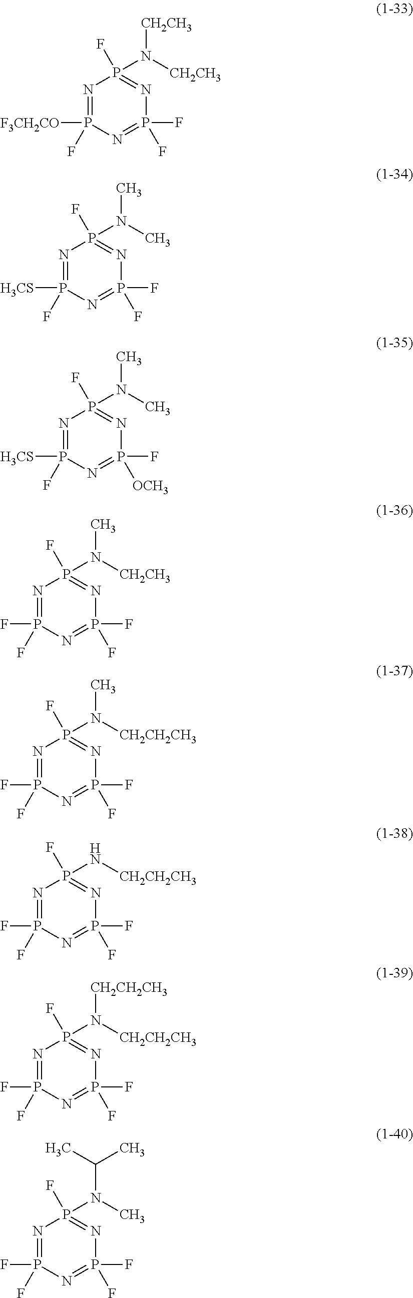

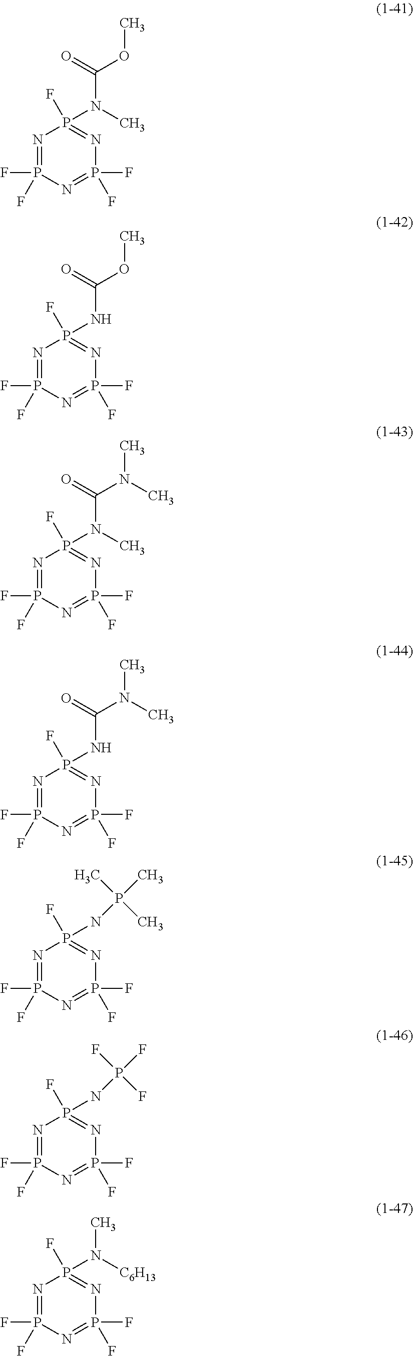

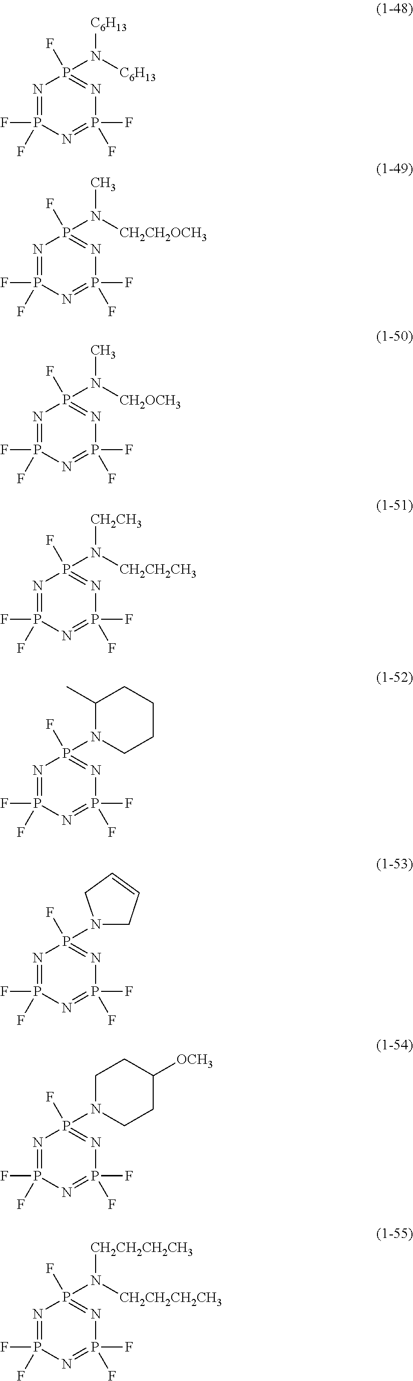

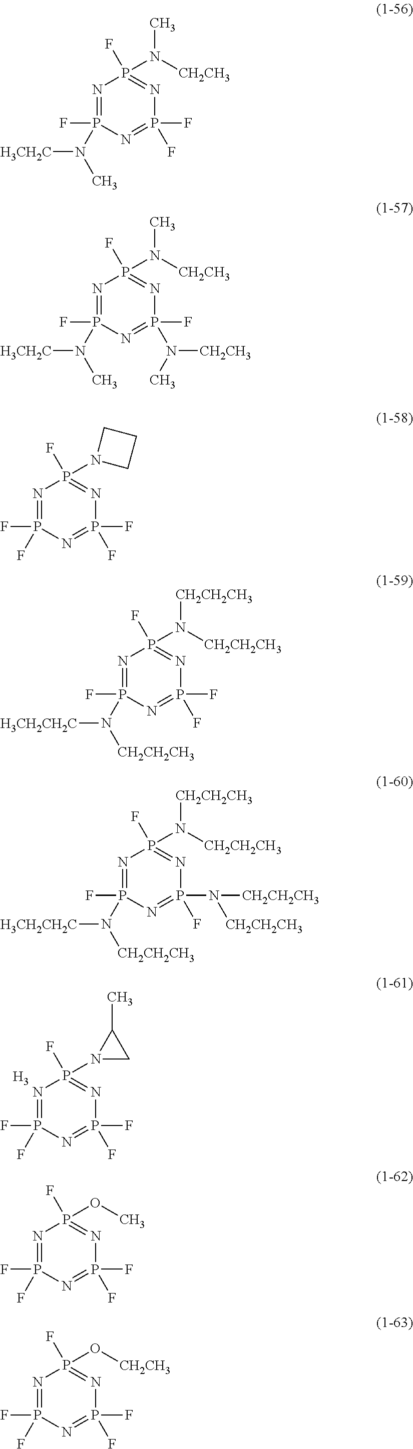

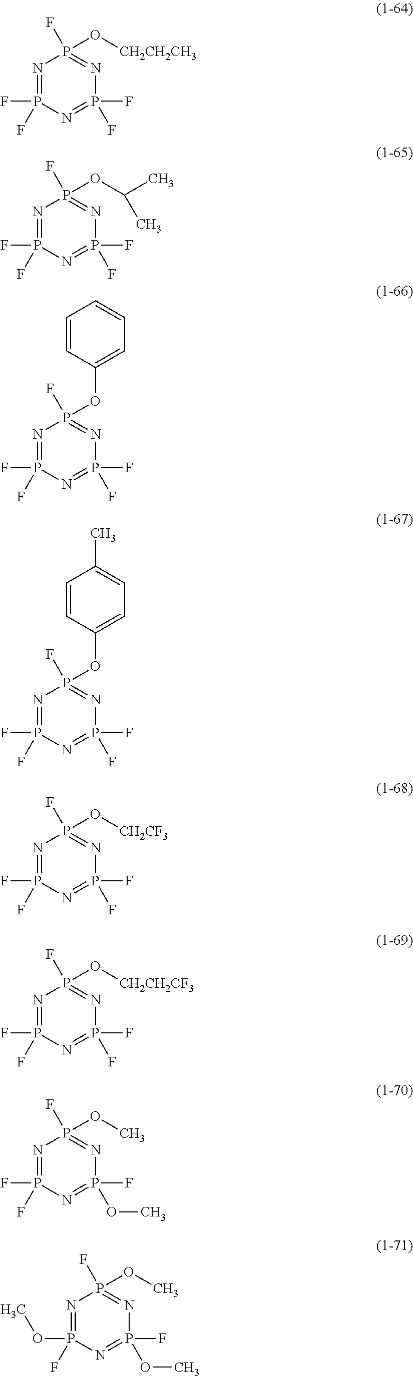

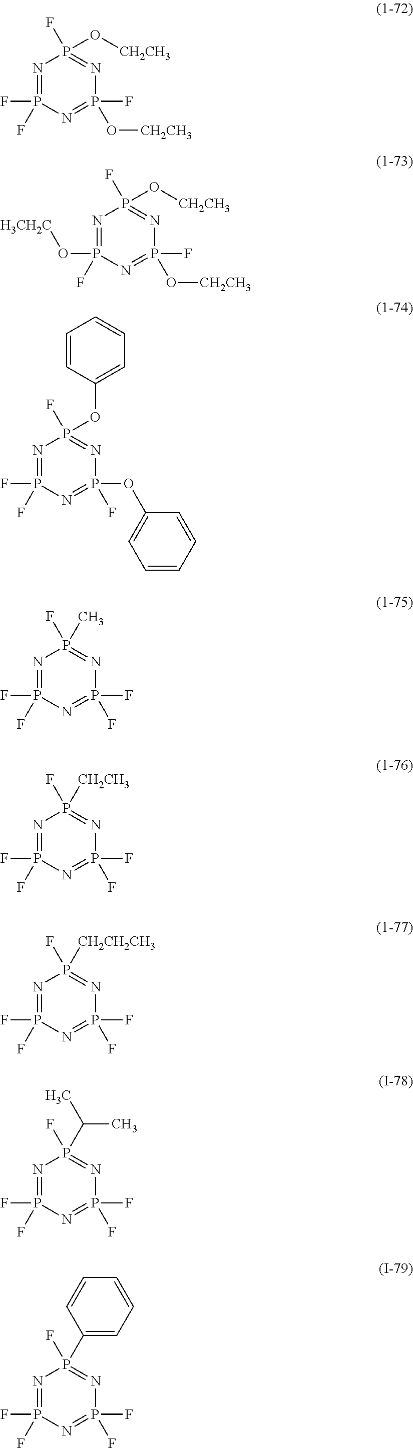

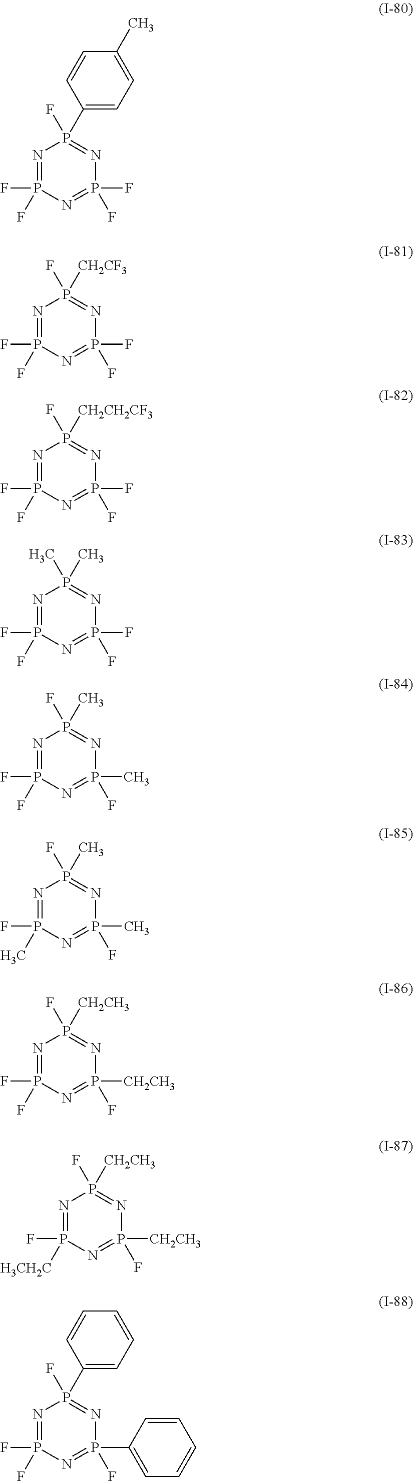

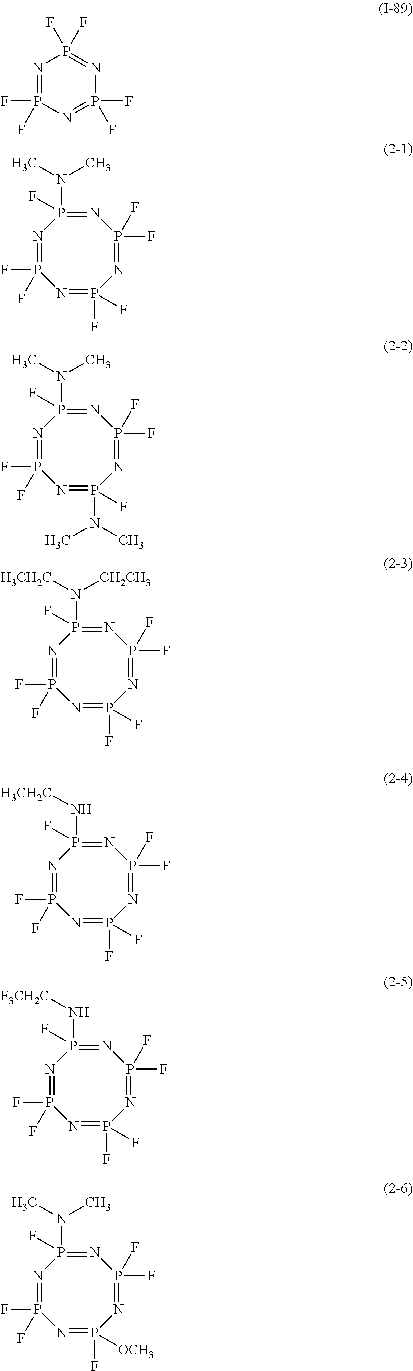

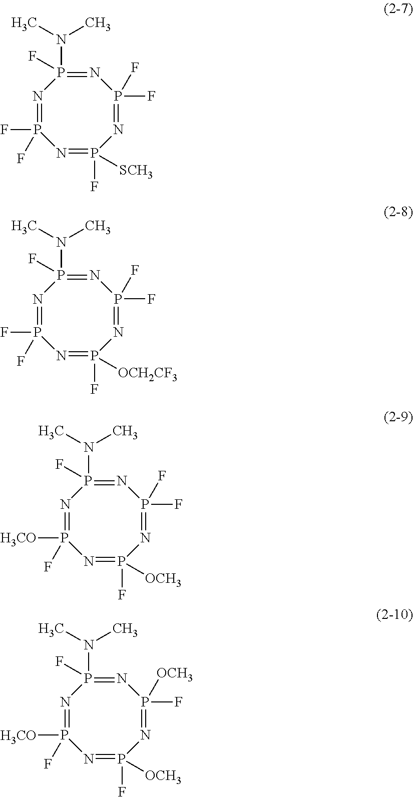

The compound represented by the formula (1) can be synthesized using an conventional method with reference to, for example, a method described in DE2139691B.

Moreover, a target product can also be obtained using a method of introducing an amino group that is similar to the target product into hexachlorocyclotriphosphazen and then fluorinating the obtained compound using a fluorinating agent such as sodium fluoride or potassium fluoride. When chlorocyclotriphosphazene or fluorocyclotriphosphazene is aminated using the above-described method, the same amine as that of the target product can be used as a remover for an acid to be produced. The same synthesis can be performed by causing the same amine as that of the target product, an inorganic salt, or an organic salt to be present together. The inorganic salt is preferably an inorganic salt composed of an anion and a metal cation; and more preferably an inorganic salt composed of an anion selected from a hydroxide, a carbonate, a bicarbonate, and a fluoride and a metal cation selected from an alkali metal and an alkali earth metal. The metal cation is more preferably selected from sodium, potassium, magnesium, and calcium. Specifically, preferable examples of the inorganic salt include hydroxides such as sodium hydroxide and potassium hydroxide; carbonates such as potassium carbonate, sodium carbonate, and sodium bicarbonate; and fluorides such as sodium fluoride and potassium fluoride. Preferable examples of the organic salt include trialkylamines such as triethylamine, diisopropylethylamine, methylmorpholine, and 1,8-diazabicyclo[5.4.0]undec-7-ene; and aromatic bases such as pyridine and lutidine. As a solvent used during this synthesis, a commonly-used solvent can be used without any problems, and preferable examples thereof include ester solvents, ether solvents, nitrile solvents, and aliphatic solvents. Specifically, preferable examples of the solvent include ester solvents such as ethyl acetate and butyl acetate; ether solvents such as diethyl ether, tert-butyl methyl ether, and cyclopentyl methyl ether; nitrile solvents such as acetonitrile; and aliphatic solvents such as hexane and decane. Among these, ether solvents or nitrile solvents are preferable.

The concentration of the phosphazene compound in the electrolytic solution according to the present invention is not particularly limited, but is preferably 0.01 mol/L to 5 mol/L, more preferably 0.02 mol/L to 1 mol/L, and still more preferably 0.05 mol/L to 0.5 mol/L. By applying the phosphazene compound in the above-described range, a combination effect (interaction) with a surfactant described below is obtained, and both flame retardancy and battery characteristics such as rate characteristics can be achieved at an extremely high level. In terms of mass, the concentration of the phosphazene compound is preferably 0.5 mass % or higher, more preferably 1 mass % or higher, and still more preferably 3 mass % or higher. The upper limit of the concentration is preferably 15 mass % % or lower, more preferably 10 mass % or lower, and still more preferably 7 vol % or lower.

[Non-Protonic Solvent]

The non-aqueous electrolytic solution according to the present invention contains an non-aqueous electrolytic solution, and it is preferable that the aprotic solvent contains a compound represented by the following formula (4A), (4B), or (4C).

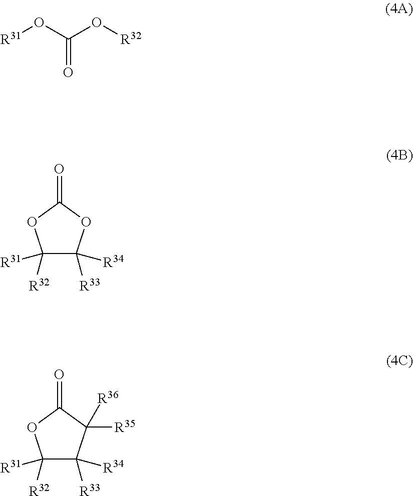

R³¹ to R³⁶

In the formula, R³¹ to R³⁶ each independently represents a hydrogen atom, an alkyl group that is substituted with a fluorine atom, an alkyl group having an ether chain, or an aryl group that is substituted with a fluorine atom. Preferable examples of the alkyl group and the aryl group are as follows. That is, R³¹ to R³⁶ each independently represents preferably a linear or branched alkyl group, an alkyl group having a fluorine atom, or a linear or branched alkyl group having an ether chain; and more preferably an alkyl group having 1 to 6 carbon atoms, an alkyl group having 1 to 6 carbon atoms that is partially substituted with a fluorine atom, or an alkyl group having 1 to 6 carbon atoms that contains an ether group. As described above, adjacent substituents may form a ring. In particular, substituents R³¹ and R³² or substituents R³³ and R³⁴ in the formula (4B) may form a ring. In addition, substituents R⁻and R³², substituents R³³ and R³⁴, or substituents R³⁵ and R³⁶ in the formula (4C) may form a ring.

The meaning of the compounds described in this specification include not only the compounds themselves but also salts and ions thereof. In addition, derivatives obtained by modifying a part of the compounds within a range where the desired effects are exhibited are also included.

The substituents (the same shall be applied to linking groups) which are not specified in this specification regarding whether to be substituted or unsubstituted may have an arbitrary substituent. The same shall be applied to the compounds which are not specified in this specification regarding whether to be substituted or unsubstituted. Preferable examples of the substituent include a substituent T described below.

Examples of the substituent T are as follows:

an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, or 1-carboxymethyl); an alkenyl group (preferably an alkenyl group having 2 to 20 carbon atoms, for example, vinyl, allyl, or oleyl); an alkynyl group (preferably an alkynyl group having 2 to 20 carbon atoms, for example, ethynyl, butadiynyl, or phenyl-ethynyl); a cycloalkyl group (preferably a cycloalkyl group having 3 to 20 carbon atoms, for example, cyclopropyl, cyclopentyl, cyclohexyl, or 4-methylcyclohexyl); an aryl group (preferably an aryl group having 6 to 26 carbon atoms, for example, phenyl, 1-naphthyl, 4-methoxyphenyl, 2-chlorophenyl, or 3-methylphenyl); a heterocyclic group (preferably a heterocyclic group having 2 to 20 carbon atoms and more preferably a 5-membered or 6-membered heterocyclic group having at least one oxygen atom, sulfur atom, or nitrogen atom, for example, 2-pyridyl, 4-pyridyl, 2-imidazolyl, 2-benzimi dazolyl, 2-thiazolyl, or 2-oxazolyl); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); an alkoxycarbonyl group (preferably an alkoxycarbonyl group having 2 to 20 carbon atoms, for example, ethoxycarbonyl or 2-ethylhexyloxycarbonyl); an amino group (preferably an amino group having 0 to 20 carbon atoms, an alkylamino group, or an arylamino group, for example, amino, N,N-dimethylamino, N,N-diethylamino, N-ethylamino, or anilino); a sulfamoyl group (preferably a sulfamoyl group having 0 to 20 carbon atoms, for example, N,N-dimethylsulfamoyl or N-phenylsufamoyl); an acyl group (preferably an acyl group having 1 to 20 carbon atoms, for example, acetyl, propionyl, butyryl, or benzoyl); an acyloxy group (preferably an acyloxy group having 1 to 20 carbon atoms, for example, acetyloxy or benzoyloxy); a carbamoyl group (preferably a carbamoyl group having 1 to 20 carbon atoms, for example, N,N-dimethylcarbamoyl or N-phenylcarbamoyl); an acylamino group (preferably an acylamino group having 1 to 20 carbon atoms, for example, acetylamino or benzoylamino); a sulfonamide group (preferably a sulfonamide group having 0 to 20 carbon atoms, for example, methanesulfonamide, benzenesulfonamide, N-methylmethanesulfonamide, or N-ethylbenzenesulfonamide); an alkylthio group (preferably an alkylthio group having 1 to 20 carbon atoms, for example, methylthio, ethylthio, isopropylthio, or benzylthio); an arylthio group (preferably an arylthio group having 6 to 26 carbon atoms, for example, phenylthio, 1-naphthylthio, 3-methylphenylthio, or 4-methoxyphenylthio); an alkylsulfonyl or arylsulfonyl group (preferably an alkylsulfonyl or arylsulfonyl group having 1 to 20 carbon atoms, for example, methylsulfonyl, ethylsulfonyl, or benzenesulfonyl); a hydroxyl group; a cyano group; and a halogen atom (for example, a fluorine atom, a chlorine atom, a bromine atom, or an iodine atom). Among these, an alkyl group, an alkenyl group, an aryl group, a heterocyclic group, an alkoxy group, an aryloxy group, an alkoxycarbonyl group, an amino group, an acylamino group, a hydroxyl group, or a halogen atom is more preferable, and an alkyl group, an alkenyl group, a heterocyclic group, an alkoxy group, an alkoxycarbonyl group, an amino group, an acylamino group, or an hydroxyl group is still more preferable.

In addition, each exemplary group of the substituent T may be further substituted with the substituent T.

When a compound or a substituent, a linking group, or the like of the compound contains, for example, an alkyl group, an alkylene group, an alkenyl group, or an alkenylene group, these groups may be cyclic or chain, may be linear or branched, and may be substituted or unsubstituted as described above. In addition, when a compound or a substituent, a linking group, or the like of the compound contains, for example, an aryl group or a heterocyclic group, these groups may be monocyclic or polycyclic and may be substituted or unsubstituted as described above.

In this specification, technical features including the selection of a substituent or a linking group of a compound, a temperature, and a thickness can be combined with each other although the lists thereof are individually described.

[Electrolyte]

Examples of the electrolyte which can be used in the electrolytic solution according to the present invention include a metal ion or a salt thereof. A metal ion in Group I or Group II of the periodic table or a salt thereof is preferable. Specifically, the electrolyte can be appropriately selected according to the intended purpose of the electrolytic solution, and examples thereof include a lithium salt, a potassium salt, a sodium salt, a calcium salt, and a magnesium salt. Among these a lithium salt is preferable from the viewpoint of output. When the electrolytic solution according to the present invention is used for an electrolyte of a non-aqueous electrolytic solution for a lithium secondary battery, a lithium salt is preferably selected as a salt of a metal ion. The lithium salt is not particularly limited, but a lithium salt which is typically used for an electrolyte of a non-aqueous electrolytic solution for a lithium secondary battery is preferable. Preferable examples of the lithium salt are as follows.

(L-1): inorganic lithium salts including: inorganic fluoride salts such as LiPF₆, LiBF₄, LiAsF₆, and LiSbF₆; perhalogenate salts such as LiClO₄, LiBrO₄, and LilO₄; and inorganic chloride salts such as LiAlCl_{4.}

(L-2): fluorine-containing organic lithium salts including: perfluoroalkanesulfonate salts such as LiCF₃SO₃; perfluoroalkanesulfonylimide salts such as LiN(CF₃SO₂)₂, LiN(CF₃CF₂SO₂)₂, LiN(FSO₂)₂, and LiN(CF₃SO₂)(C₄F₉SO₂); perfluoroalkanesulfonylmethide salts such as LiC(CF₃SO₂)₃; fluoroalkyl fluorophosphates such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃].

(L-3): oxalato borates including: lithium bis(oxalato)borate and lithium difluoro(oxalato) borate.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂)₂ are preferable, and lithium imide salts such as LiPF₆, LiBF₄, LiN(Rf¹SO₂)₂, LiN(FSO₂)₂, and LiN(Rf¹SO₂)(Rf²SO₂)₂ are more preferable. Here, Rf¹ and Rf² each independently represents a perfluoroalkyl group.

Among these lithium salts used in the electrolytic solution, one kind may be used alone, or two or more kinds may be used in an arbitrary combination.

The concentration of the electrolyte (preferably an ion or a salt of a metal in Group I or Group II in the periodic table) in the electrolytic solution is adjusted such that a preferable concentration described in the following preparation method of the electrolytic solution is obtained. This concentration of the electrolyte can be appropriately selected according to the intended purpose of the electrolytic solution. In general, the concentration is preferably 10 mass % to 50 mass % and more preferably 15 mass % to 30 mass % with respect to the total mass of the electrolytic solution. When being evaluated as the ion concentration, the concentration of the electrolyte may be calculated in terms of a salt thereof with a metal which is preferably used.

[Other Components]

The electrolytic solution according to the present invention may contain at least one selected from a negative electrode film forming agent, and an overcharge inhibitor. The content of each of these functional additives in the non-aqueous electrolytic solution is not particularly limited, but is preferably 0.001 mass % to 10 mass % with respect to the total mass of the non-aqueous electrolytic solution.

[Preparation Method of Electrolytic Solution and the Like]

The non-aqueous electrolytic solution can be prepared with a conventional method by dissolving the above-described respective components in the above-described solvent for a non-aqueous electrolytic solution, the components including the example in which a lithium salt is used as a salt of a metal ion.

In the present invention, “non-aqueous” represents substantially not containing water. The non-aqueous electrolytic solution may contain a small amount of water in a range where the effects of the present invention do not deteriorate. In consideration of obtaining superior characteristics, the concentration of water is preferably 200 ppm or lower (in terms of mass) and more preferably 100 ppm or lower. The lower limit is not particularly limited but, in practice, is 10 ppm or higher in consideration of unavoidable incorporation. The viscosity of the electrolytic solution according to the present invention is not particularly limited, but the viscosity at 25° C. is preferably 10 mPa·s to 0.1 mPa·s and more preferably 5 mPa·s to 0.5 mPa·s.

[Kit]

The electrolytic solution according to the present invention may be a kit that is composed of plural liquids, powders, and the like. For example, the electrolytic solution may be prepared by mixing two liquids each other before use, the two liquids including: a first agent (first liquid) that is composed of an electrolyte and an organic solvent; and a second agent (second liquid) that is composed of a flame retardant and an organic solvent. At this time, in the kit according to the present invention, other additives may be added to the first agent, the second agent, and/or another agent (third agent) in advance.

[Separator]

Here, a preferred embodiment of a separator which is adopted in the present invention will be described. It is preferable that the separator is formed of a material that has insulating properties for electronically insulates the positive electrode and the negative electrode, mechanical strength, ion permeability, and oxidation-reduction resistance at a contact surface between the positive electrode and the negative electrode. As such a material, for example, a porous polymer material, an inorganic material, an organic-inorganic hybrid material, or a glass fiber is used. In order to secure safety, it is preferable that the separator has a shutdown function, that is, a function of interrupting the current by blocking pores at 80° C. or higher to increase resistance. The blocking temperature is preferably 90° C. to 180° C.

In the present invention, the separator has a complex that is composed of a heat-resistant material and a non-heat-resistant material. The embodiment will be described below.

In the embodiment, the complex forming the separator is composed of a substrate containing a non-heat-resistant resin and a heat-resistant material coating the substrate. The heat-resistant material is preferably a heat-resistant resin. When a glass transition point of a resin constituting the separator substrate is represented by Tg1, and when a glass transition point of a heat-resistant resin coating the separator substrate is represented by Tg2, a difference (ΔTg=Tg2−Tg1) between the glass transition points is preferably 30° C. or higher and more preferably 50° C. or higher. The upper limit of the difference is 250° C. or lower and more preferably 200° C. or lower.

Heat-Resistant Material

When a heat-resistant resin is used as the heat-resistant material, the heat-resistant resin is preferably selected from a polyamide resin, a polyimide resin (for example, an aramid resin), polyacrylonitrile, polyethylene terephthalate (PET), polyfluoroethylene (for example, polytetrafluoroethylene or a copolymer thereof), and polymethylpentene. The molecular weight of the heat-resistant resin is not particularly limited, but is preferably 5,000 to 1,000,000 and more preferably 10,000 to 500,000. It is preferable that the heat-resistant material is fibrous or particulate. By using the fibrous or particulate material, the heat-resistant resin does not hinder a porous structure of the separator substrate, and superior ion permeability is maintained, which is preferable.

As the polyamide resin, an aramid resin is preferably used. Regarding the aramid resin, a commonly-used aramid resin can be used, and the material and processing method thereof can refer to, for example, JP2011-108593A, JP2009-087948A, JP2006-054127A, and JP2005-307360A

The heat-resistant material may be an inorganic material. Examples of the inorganic material contain alumina and silica. At this time, due to the same reason as described above, it is preferable that alumina or silica is added in a form in which permeability can be maintained. Further, for example, a nitride such as aluminum nitride or silicon nitride, or barium sulfate can be applied. The average primary particle size of inorganic particles is preferably 1 μm to 100 μm and more preferably 1 μm to 15 μm. As this average particle size, a nominal value may be adopted, but the number average particle size of 50 particles may be adopted by obtaining the circle equivalent diameter of each particle through electronic microscopic observation.

The thickness of a coating layer formed by using the heat-resistant material is not particularly limited, but is preferably 1 μm or more, more preferably 2 μm or more, and still more preferably 5 μm or more. The upper limit of the thickness is preferably 100 μm or less, more preferably 50 μm or less, and still more preferably 20 μm or less.

The coating layer formed by using the heat-resistant material may contain a material other than the heat-resistant material, and the content of the heat-resistant material is preferably 25 mass % or higher and more preferably 40 mass % or higher. The upper limit of the content is not particularly limited, but is practically 70% mass % or lower.

Non-Heat-Resistant Resin

It is preferable that the non-heat-resistant resin is polyethylene (PE) or polypropylene (PP). The molecular weight of polyethylene or polypropylene is not particularly limited, but is preferably 5000 to 700,000 and more preferably 10,000 to 500,000. In the embodiment, it is preferable that a non-heat-resistant resin constitutes the separator substrate. It is preferable that the separator substrate is a microporous film, and the shape of pores is typically circular or elliptical. The pore size is preferably 0.05 μm to 30 μm and more preferably 0.1 μm to 20 μm. Further, the shape of the pores may be rod-like or indefinite as in a case where a separator is prepared using a drawing method or a phase separation method. An occupancy ratio of the pores, that is, a porosity (void ratio) is 20% to 90% and preferably 35% to 80%. A laminate of two or more microporous films having different pore sizes, porosities, and pore blocking temperatures is also preferable. Alternatively, regarding the separator substrate using non-woven fabric, the average pore size is preferably 0.01 μm to 1 μm, and the thickness is preferably 5 μm to 50 μm.

The substrate containing a non-heat-resistant resin may contain inorganic particles such as silica particles or alumina particles, or a powder silica gel as a filler. Alternatively, the substrate may contain another resin such as polyester.

The thickness of the substrate containing a non-heat-resistant resin is not particularly limited, but is preferably 2 μm or more, more preferably 5 μm or more, and still more preferably 10 μm or more. The upper limit of the thickness is preferably 100 μm or less, more preferably 50 μm or less, and still more preferably 30 μm or less.

The substrate containing a non-heat-resistant material may contain a material other than the non-heat-resistant resin as described above, but the content of the non-heat-resistant resin is preferably 20 mass % or higher and more preferably 40 mass % or higher. The upper limit of the content is not particularly limited, but is practically 90% mass % or lower.

In the present invention, unless specified otherwise, the molecular weight and the dispersity are values obtained by measurement using GPC (gel permeation chromatography), and the molecular weight is a number average molecular weight in terms of polystyrene. A gel which is filled into a column used for GPC is preferably a gel containing an aromatic compound as a repeating unit, and examples thereof include a gel formed of a styrene-divinylbenzene copolymer. Regarding the column, it is preferable that 2 to 6 columns are connected. Unless specified otherwise, tetrahydrofuran is used as a solvent. In the measurement, the flow rate of the solvent is preferably in a range of 0.1 mL/min to 2 mL/min and most preferably in a range of 0.5 mL/min to 1.5 mL/min. By performing the measurement in this range, a load is not applied to an apparatus, and the measurement can be more efficiently performed. The measurement temperature is preferably 10° C. to 50° C. and most preferably 20° C. to 40° C. The column and carrier to be used are appropriately selected depending on physical properties of a polymer compound which is a measurement object, but a column (manufactured by Tosoh Corporation) is used unless specified otherwise. Specifically, in the measurement, tetrahydrofuran or the like is used as the solvent, a polystyrene gel (TSK gel, manufactured by Tosoh Corporation) is used, and an equivalent molecular weight calibration curve which is determined in advance from a constitution curve of standard monodisperse polystyrene is used.

The working mechanism of the secondary battery according to the present invention is not completely clear, but is presumed to be as follows. That is, in a preferred embodiment of the present invention, as the flame retardant, a compound having a specific polar site derived from a phosphorus atom or a nitrogen atom is adopted. On the other hand, as the separator, not a separator formed of a polyolefin material but a separator which contains a resin or inorganic material having a specific polar site on a surface thereof may be adopted. As a result, it is considered that the wettability between the flame retardant and the separator is enhanced, and even when a structure of imparting heat resistance to the separator is adopted, high battery performance (cycle characteristics) can be achieved.

[Secondary Battery]

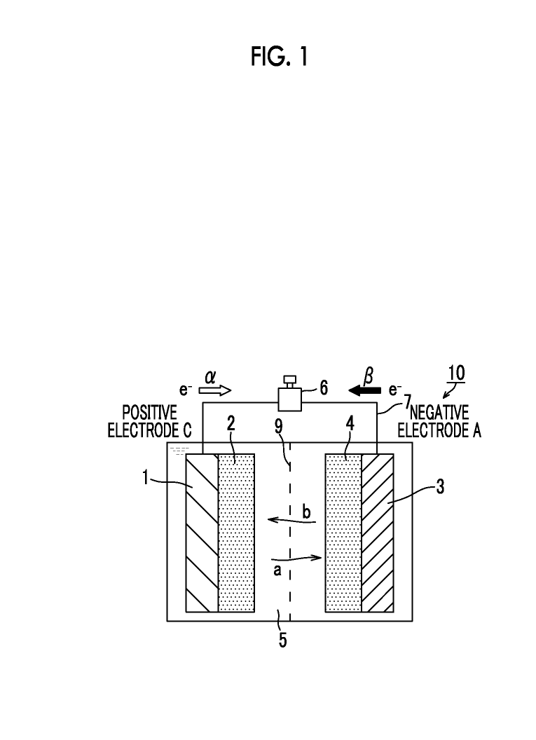

It is preferable that a non-aqueous electrolytic solution secondary battery according to the present invention contains the non-aqueous electrolytic solution. A lithium secondary battery according to a preferred embodiment of the present invention will be described with reference to FIG. 1 schematically showing a mechanism thereof. However, FIG. 1 and the description based on FIG. 1 are not intended to limit the present invention.

The lithium secondary battery 10 according to the embodiment includes: the above-described non-aqueous electrolytic solution 5 according to the present invention; a positive electrode C (including a positive electrode current collector 1 and a positive electrode active material layer 2) capable of storing and releasing lithium ions; and a negative electrode A (including a negative electrode current collector 3 and a negative electrode active material layer 4) capable of storing and releasing or dissolving or depositing lithium ions. In addition to these essential components, the lithium secondary battery 10 may further include, for example, a separator 9 that is disposed between the positive electrode and the negative electrode, a current collector terminal (not shown), and an outer case (not shown) in consideration of the intended use of the battery, the form of the potential, and the like. Optionally, a protective element may be mounted at least either inside or outside the battery. With such a structure, lithium ions in the electrolytic solution 5 are stored (a) and released (b), the battery can be charged (α) and discharged (β), and an operating mechanism 6 can operate and store electricity through a circuit wiring 7.

(Battery Shape)

The battery shape which is applied to the lithium secondary battery according to the embodiment is not particularly limited and may be, for example, a bottomed cylindrical shape, a bottomed square shape, a thin shape, a sheet shape, a paper shape, and a combination thereof. In addition, the battery shape may be a horseshoe shape or a comb shape in consideration of the form of a system or an apparatus to be incorporated. From the viewpoints of efficiently dissipating heat generated in the battery to the outside, the battery shape is preferably a square shape such as a bottomed square shape or a thin shape having at least one relatively flat surface with a large area.

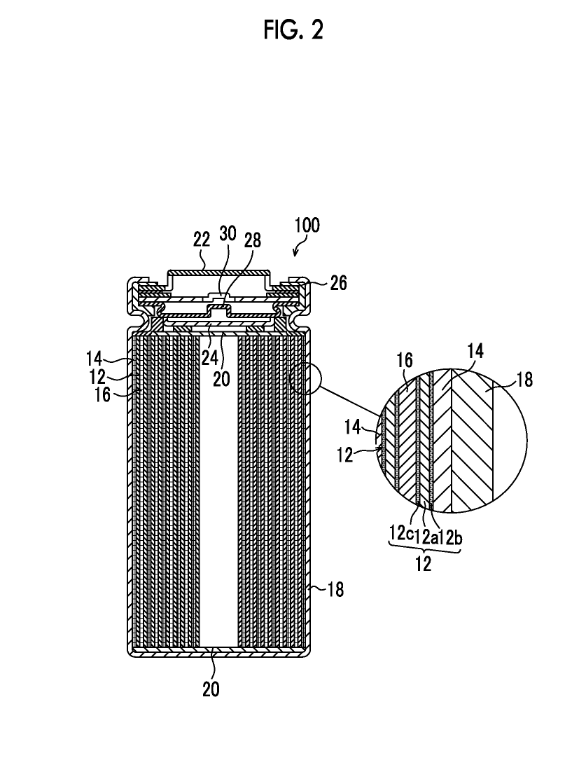

In a bottomed cylindrical battery, the outer surface area relative to a power generating element to be charged is reduced. Therefore, the battery preferably has a design in which Joule's heat generated due to internal resistance during charging or discharging is efficiently dissipated to the outside. In addition, the battery preferably has a design in which the packing ratio of a material having high thermal conductivity is improved so as to decrease an internal temperature distribution. The bottomed cylindrical secondary battery will be described below with reference to FIG. 2.

(Components Constituting Battery)

Referring to FIG. 1, the lithium secondary battery according to the embodiment includes the electrolytic solution 5, the positive electrode and the negative electrode C and A which are electrode mixtures, and the separator 9 which is a base component. Hereinafter, the respective components will be described.

(Electrode Mixture)

The electrode mixture is obtained by coating a current collector (electrode base material) with a dispersion of an active material, a conductive material, a binder, a filler, and the like and forming the coated material into a sheet shape. Typically, in a lithium battery, a positive electrode mixture including a positive electrode active material as an active material and a negative electrode mixture including a negative electrode active material as an active material are used. Next, the respective components in the dispersion (the mixture and the electrode composition) constituting the electrode mixture will be described.

Positive Electrode Active Material

In the electrode mixture for a secondary battery, a particulate positive electrode active material may be used. As the positive electrode active material, a transition metal oxide that can reversibly store and release lithium ions can be used, and a lithium-containing transition metal oxide is preferably used. Preferable examples of the lithium-containing transition metal oxide which can be used as the positive electrode active material include lithium-containing oxides containing Ti, V, Cr, Mn, Fe, Co, Ni, Cu, Mo, and W. In addition, alkali metals other than lithium (elements in Group 1 (IA) and Group 2 (IIA) in the periodic table) and/or Al, Ga, In, Ge, Sn, Pb, Sb, Bi, Si, P, B, and the like may be mixed with the transition metal oxide. The mixing amount is preferably 0 mol % to 30 mol % with respect to the transition metal. When an oxide containing Ni and/or Co and/or Mn is used as the positive electrode active material, the effects of the present invention are significantly high.

Among the lithium-containing transition metal oxides which is preferably used as the positive electrode active material, a lithium-containing transition metal oxide which is synthesized by mixing a lithium compound and a transition metal compound (here, the transition metal refers to at least one selected from Ti, V, Cr, Mn, Fe, Co, Ni, Mo, and W) with each other such that a total molar ratio thereof is 0.3 to 2.2 is more preferable.

Further, as the lithium compound and the transition metal compound, a material containing Li_{g}M3O₂ (wherein M3 represents one or more elements selected from Co, Ni, Fe, and Mn; and g represents 0 to 1.2) or a material having a spinel structure represented by LiₕM4₂O (wherein M4 represents Mn; and h represents 0 to 2) is more preferable. As M3 and M4, for example, Al, Ga, In, Ge, Sn, Pb, Sb, Bi, Si, P, or B may be added in addition to the transition metal. The mixing amount is preferably 0 mol % to 30 mol % with respect to the transition metal.

As the material containing Li_{g}M3O₂ and the material having a spinel structure represented by LiₕM4₂O₄, Li_{g}CoO₂, Li_{g}NiO₂, Li_{g}MnO₂, Li_{g}CoⱼNi₁₋ⱼO₂, LiₕMn₂O₄, LiNiⱼMn₁₋ⱼO₂, LiCoⱼNiₕAl₁₋ⱼ₋ₕO₂, LiCoⱼNiₕMn₁₋ⱼ₋ₕO₂, LiMnₕAl₂₋ₕO₄, or LiMnₕNi₂₋ₕO₄, (wherein g represents 0.02 to 1.2; j represents 0.1 to 0.9; and h represents 0 to 2) is preferable; and Li_{g}CoO₂, LiₕMn₂O₄, LiCoⱼNiₕAl₁₋ⱼ₋ₕO₂, LiCoⱼNiₕMn₁₋ⱼ₋ₕO₂, LiMnₕAl₂₋ₕO₄, or LiMnₕNi₂₋ is more preferable. From the viewpoints of high capacity and high output, an electrode containing Ni is still more preferable among the above-described electrodes. Here, the g value and h value are values before the start of charging and discharging and are values which are increased and decreased due to charging and discharging. Specific examples include LiCoO₂, LiNi_{0.85}Co_{0.01}Al_{0.05}O₂, LiNi_{0.33}Co_{0.33}Mn_{0.33}O₂, LiMn_{1.8}Al_{0.2}O₄, and LiMn_{1.5}Ni_{0.5}O₄.

As the transition metal of the lithium-containing transition metal phosphate compound, for example, V, Ti, Cr, Mn, Fe, Co, Ni, or Cu is preferable, and specific examples thereof include iron phosphates such as LiFePO4, Li3Fe2(PO4)3, and LiFeP2O7; cobalt phosphates such as LiCoPO₄; and compounds in which a portion of transition metal atoms which are a major component of the lithium transition metal phosphate compound is substituted with another metal such as Al, Ti, V, Cr, Mn, Fe, Co, Li, Ni, Cu, Zn, Mg, Ga, Zr, Nb, or Si.

In the present invention, as the positive electrode active material, a material having a charging region of 4.25 V or higher is preferably used. Specifically, a lithium-containing transition metal oxide having a lithium storage-release potential peak of 4.25 V or higher against lithium is preferable. At this time, the charge-discharge potential peak can be specified by preparing a thin film electrode of the positive electrode active material using a sol-gel method or a sputtering method and performing electrochemical measurement (cyclic voltammetry) thereon.

Examples of the positive electrode active material having the specific charging region are as follows.

LiNiₓMn_{y}Co_{z}O₂ (x>0.2, y>0.2, z≧0, x+y+z=1) (i)
representative example:
LiNi_{1/3}Mn_{1/3}Co_{1/3}O₂ (also referred to as LiNi_{0.33}Mn_{0.33}Co_{0.33}O₂)
LiNi_{1/2}Mn_{1/2}O₂ (also referred to as LiNi_{0.5}Mn_{0.5}Co_{0.33}O₂)

LiNiₓMn_{y}O₄ (x>0.2, y>0.7, x+y=1) (ii)
representative example:
LiNi_{1/4}Mn_{3/4}O₂ (also referred to as LiNi_{0.5}Mn_{1.5}O₄)

LiNiₓCo_{y}Al_{z}O₂ (x>0.7, y>0.1, 0.1>z>0.05, x+y+z=1) (iii)
representative example:
LiNi_{0.8}Co_{0.15}Al_{0.05}O₂

As the positive electrode active material having the specific charging region, the following compounds can be used.
(a) LiCoMnO₄
(b) Li₂FeMn₃O₈
(c) Li₂CuMn₃O₈
(d) Li₂CrMn₃O₈
(e) Li₂NiMn₃O₈

In the non-aqueous electrolytic solution secondary battery according to the present invention, a particulate positive electrode active material may be used. The average particle size of the positive electrode active material to be used is not particularly limited but is preferably 0.1 μm to 50 μm. The specific surface area is not particularly limited but is preferably 0.01 m²/g to 50 m²/g when measured using the BET method. In addition, when 5 g of the positive electrode active material is dissolved in 100 ml of distilled water, the pH of the supernatant liquid is preferably 7 to 12.

In order for the positive electrode active material to have a predetermined particle size, a commonly-used pulverizer or classifier can be used. For example, a mortar, a ball mill, a vibration ball mill, a vibration mill, a satellite ball mill, a planetary ball mill, a swirling air flow jet mill, or a sieve is used. The positive electrode active material obtained using the calcination method may be used after being washed with water, an acidic aqueous solution, an alkaline aqueous solution, or an organic solvent.

The mixing amount of the positive electrode active material is not particularly limited, but the mixing amount in the dispersion (mixture) constituting the electrode mixture is preferably 60 mass % to 98 mass % and more preferably 70 mass % to 95 mass % with respect to 100 mass % of the solid components.

Negative Electrode Active Material

The negative electrode active material is not particularly limited, but is preferably a material that can reversibly store and release lithium ions, and examples thereof include carbonaceous materials; metal oxides such as tin oxide and silicon oxide; metal composite oxides; lithium and lithium alloys such as a lithium-aluminum alloy; and metals capable of forming an alloy with lithium, such as Sn and Si.

Among these, one kind may be used alone, or two or more kinds may be used in an arbitrary combination at an arbitrary ratio. Among these, carbonaceous material or lithium metal composite oxides are preferably used from the viewpoint of safety.

In addition, the metal composite oxide is not particularly limited but is preferably an oxide that can store and release lithium. It is preferable that the metal composite oxide contains titanium and/or lithium as a constituent element from the viewpoint of high current density charging-discharging characteristics.

The carbonaceous material which is used as the negative electrode active material is a material substantially containing carbon. Examples of the carbonaceous material include petroleum pitch, natural graphite, artificial graphite such as vapor-grown graphite, and carbonaceous materials obtained by firing various synthetic resins such as PAN resins and furfuryl alcohol resins. Further, other examples of the carbonaceous material include various carbon fibers such as PAN-based carbon fibers, cellulose-based carbon fibers, pitch-based carbon fibers, vapor-grown carbon fibers, dehydrated PVA-based carbon fibers, lignin carbon fibers, vitreous carbon fibers, activated carbon fibers; mesophase microspheres; graphite whiskers; and tabular graphite.

These carbonaceous materials can be classified into non-graphitizable carbonaceous materials and graphitizable carbonaceous materials based on the graphitization degree. In addition, it is preferable that the carbonaceous material has the lattice spacing, density, and crystallite size described in JP1987-22066A (JPS62-22066A), JP1990-6856A (JPH2-6856A), and JP1991-45473A (JPH3-45473A). The carbonaceous material is not necessarily a single material and, for example, may be a mixture of natural graphite and artificial graphite described in JP1993-90844A (JPH5-90844A) or graphite having a coating layer described in JP 1994-4516A (JPH6-4516A).

It is preferable that at least one kind of the metal oxide and the metal composite oxide, which are negative electrode active materials used in the non-aqueous electrolytic solution secondary battery, is included. The metal oxide and the metal composite oxide are more preferably amorphous oxides. Further, chalcogenides which are reaction products between metal elements and elements in Group 16 of the periodic table are preferably used. “Amorphous” described herein represents an oxide having a broad scattering band with a peak in a range of 20° to 40° in terms of 2θ when measured by an X-ray diffraction method using CuKα rays, and the oxide may have a crystal diffraction line. The highest intensity in a crystal diffraction line observed in a range of 40° to 70° in terms of 2θ is preferably 100 times or less and more preferably 5 times or less relative to the intensity of a diffraction peak line in a broad scattering band observed in a range of 20° to 40° in terms of 2θ, and it is still more preferable that the oxide does not have a crystal diffraction line.

In a group of compounds consisting of the amorphous oxides and the chalcogenides, amorphous oxides and chalcogenides of metalloid elements are more preferable, and oxides and chalcogenides formed of a single element or a combination of two or more elements selected from elements in Groups 13 (IIIB) to 15 (VB) of the periodic table, Al, Ga, Si, Sn, Ge, Pb, Sb, and Bi are still more preferable. Specifically, preferable examples of the amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. In addition, composite oxides of these examples with lithium oxide, for example, Li₂SnO₂ may be used.

In the non-aqueous electrolytic solution secondary battery, the average particle size of the negative electrode active material to be used is preferably 0.1 μm to 60 μm. In order to obtain the predetermined particle size, a well-known pulverizer or classifier is used. For example, a mortar, a ball mill, a sand mill, a vibration ball mill, a satellite ball mill, a planetary ball mill, a swirling air flow jet mill, or a sieve is preferably used. During the pulverization, wet pulverization of causing water or an organic solvent such as methanol to coexist with the negative electrode active material can be optionally performed. In order to obtain a desired particle size, it is possible to perform classification. A classification method is not particularly limited, and a method using, for example, a sieve or an air classifier can be optionally used. The classification can be used using a dry method or a wet method.

The chemical formula of the compound obtained using the calcination method can be obtained by using inductively coupled plasma (ICP) optical emission spectroscopy as a measurement method, or can be calculated from a mass difference of the powder before and after calcination as a short-cut method.

Preferable examples of the negative electrode active material which can be used in combination with the amorphous oxide as negative electrode active material containing Sn, Si, or Ge as a major component include carbon materials that can store and release lithium ions or lithium metal; lithium; lithium alloys; and metals that can form an alloy with lithium.

In the present invention, lithium titanate, more specifically, lithium titanium oxide (Li[Li_{1/3}Ti_{5/3}]O₄) can be preferably used as the negative electrode active material.

The mixing amount of the negative electrode active material in the dispersion (mixture) constituting the electrode mixture is not particularly limited, but is preferably 60 mass % to 98 mass % and more preferably 70 mass % to 95 mass % with respect to 100 mass % of the solid components.

Conductive Material

Any electron conductive materials that do not cause a chemical change in a constructed secondary battery can be preferably used as the conductive material, and a well-known conductive material can be arbitrarily used. Typically, one kind or a mixture of two or more kinds can be used among the following conductive materials including: natural graphite (for example, scale-like graphite, flaky graphite, or amorphous graphite), artificial graphite, carbon black, acetylene black, Ketjen black, carbon fibers, metal powders (for example, copper, nickel, aluminum, or silver (described in JP1988-10148A (JPS63-10148A) and JP1988-554A (JPS63-554A), metal fibers, and polyphenylene derivatives (described in JP1984-20A (JPS59-20A) and JP1984-971A (JPS59-971A). Among these, a combination of graphite and acetylene black is more preferable. The addition amount of the conductive material in the dispersion (mixture) constituting the electrode mixture is preferably 0.1 mass % to 50 mass % and more preferably 0.5 mass % to 30 mass % with respect to 100 mass % of the solid components. The addition amount of carbon or graphite in the dispersion is more preferably 0.5 mass % to 15 mass %.

Binder

Examples of the binder include polysaccharides, thermoplastic resins, and polymers having rubber elasticity. Preferable examples of the binder include emulsions (latexes) or suspensions of starch, carboxymethyl cellulose, cellulose, diacetyl cellulose, methyl cellulose, hydroxyethyl cellulose, hydroxypropyl cellulose, sodium alginate, polyacrylic acid, sodium polyacrylate, water-soluble polymers (for example, polyvinyl phenol, polyvinyl methyl ether, polyvinyl alcohol, polyvinyl pyrrolidone, polyacrylonitrile, polyacrylamide, polyhydroxy (meth)acrylate, and a styrene-maleic acid copolymer), polyvinyl chloride, polytetrafluoroethylene, polyvinylidene fluoride, a tetrafluoroethylene-hexafluoropropylene copolymer, a vinylidene fluoride-tetrafluoroethylene-hexafluoropropylene copolymer, polyethylene, polypropylene, an ethylene-propylene-diene terpolymer (EPDM), a sulfonated EPDM, a polyvinyl acetal resin, (meth)acyrylic acid ester copolymers containing a (meth)acyrylic acid ester (for example, methyl methacrylate and 2-ethylhexyl acrylate), a (meth)acrylic acid ester-acrylonitrile copolymer, a polyvinyl ester copolymer containing a vinyl ester (for example, vinyl acetate), a styrene-butadiene copolymer, an acrylonitrile-butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin. More preferable examples of the binder include a polyacrylic acid ester latex, carboxymethyl cellulose, polytetrafluoroethylene, and polyvinylidene fluoride.

As the binder, one kind can be used alone, or a mixture of two or more kinds can be used. When the addition amount of the binder is excessively small, the holding force and cohesive force of the electrode mixture are weakened. When the addition amount of the binder is excessively great, the electrode volume increases, and thus the capacity per unit volume or unit mass of the electrode is decreased. Due to the above-described reasons, the addition amount of the binder in the dispersion (mixture) constituting the electrode mixture is preferably 1 mass % to 30 mass % and more preferably 2 mass % to 10 mass % with respect to 100 mass % of the solid components.

Filler

The electrode mixture may contain a filler. As a material forming the filler, any fibrous materials that do not cause a chemical change in the secondary battery according to the present invention can be preferably used. Typically, fibrous fillers formed from olefin polymers such as polypropylene and polyethylene, and materials such as glass and carbon are used. The addition amount of the filler is not particularly limited, but the addition amount in the dispersion (mixture) constituting the electrode mixture is preferably 0 mass % to 30 mass % with respect to 100 mass % of the solid components.

Current Collector

As the current collectors of the positive and negative electrodes, an electron conductor that does not cause a chemical change in the non-aqueous electrolytic solution secondary battery according to the present invention is used. As the current collector of the positive electrode, aluminum, stainless steel, nickel, titanium, or aluminum or stainless steel surface-treated with carbon, nickel, titanium, or silver is preferable. Among these, aluminum or an aluminum alloy is more preferable.

As the current collector of the negative electrode, aluminum, copper, stainless steel, nickel, or titanium is preferable, and aluminum copper, or a copper alloy is more preferable.

Regarding the shape of the current collector, a film sheet-shaped current collector is usually used, but a net-shaped material, a material formed by punching, a lath material, a porous material, a foam, a material obtained by molding a group of fibers, and the like can also be used. The thickness of the current collector is not particularly limited but is preferably 1 μm to 500 μm. In addition, it is also preferable that the surface of the current collector is made to be uneven through a surface treatment.

The electrode mixture of the lithium secondary battery is formed of components which are appropriately selected from these materials.

(Preparation of Non-aqueous Electrolyte Secondary Battery)

As described above, the lithium secondary battery may have any shape such as a sheet shape, a square shape, or a cylindrical shape. In many cases, the current collectors are coated with the mixture (dispersion) containing the positive electrode active material and the negative electrode active material, are dried, and are compressed to be used.

Hereinafter, the configuration and preparation method of the bottomed cylindrical lithium secondary battery 100 will be described as an example with reference to FIG. 2. In a bottomed cylindrical battery, the outer surface area relative to a power generating element to be charged is reduced. Therefore, the battery preferably has a design in which Joule's heat generated due to internal resistance during charging or discharging is efficiently dissipated to the outside. In addition, the battery preferably has a design in which the packing ratio of a material having high thermal conductivity is improved so as to decrease an internal temperature distribution. FIG. 2 shows the bottomed cylindrical lithium secondary battery 100 as an example. In this bottomed cylindrical lithium secondary battery 100, a wound laminate where a positive electrode sheet 14 and a negative electrode sheet 16 are superimposed with a separator 12 (a separator substrate 12b and coating layers 12a and 12c) interposed therebetween is accommodated in an outer can 18. In the drawing, reference numeral 20 represents an insulating plate, reference numeral 22 represents a sealing plate, reference numeral 24 represents a positive electrode current collector, reference numeral 26 represents a gasket, reference numeral 28 represents a pressure-sensitive valve, and reference numeral 30 represents a current interrupting element. In an enlarged circle, a hatched portion is different from that of the overall diagram in consideration of visibility, but the respective components represented by reference numerals corresponds to those in the overall diagram.

First, the negative electrode active material and various additives including the binder, the filler, and the like which are optionally used are dissolved in an organic solvent to obtain a mixture. As a result, a slurry or paste negative electrode mixture is prepared. The entire region of both surfaces of a metal core as a current collector is uniformly coated with the obtained negative electrode mixture. Next, the organic solvent is removed, and a negative electrode active material layer is formed. Further, the laminate (mixture) of the current collector and the negative electrode active material layer is rolled using a roll press machine. As a result, a negative electrode sheet (electrode sheet) having a predetermined thickness is prepared. At this time, conventional methods can be used as the coating method of the respective materials, the drying method of the coated material, and the forming method of the positive and negative electrodes.

In the embodiment, the cylindrical battery has been described as an example, but the present invention is not limited thereto. For example, after the positive and negative electrode sheets (mixtures) prepared using the above-described method are superimposed with the separator interposed therebetween, the laminate may be processed into a sheet-shaped battery as it is. Alternatively, the laminate may be folded and inserted into a square can so as to electrically connect the can and the sheet to each other, and then an electrolyte is injected thereto, and an opening is sealed using the sealing plate, thereby forming a square battery.

In all the embodiments, a safety valve can be used as the sealing plate for sealing the opening. In addition, as a sealing component, various well-known safety elements of the related art may be provided in addition to the safety valve. For example, as an overcurrent preventing element, for example, a fuse, a bimetal, or a PTC element is preferably used.

In addition, in addition to the safety valve, as a countermeasure against an increase in the internal pressure of the battery can, a method of forming a slit in the battery can, a gasket cracking method, or a sealing plate cracking method, or a method of disconnecting a lead plate can be used. In addition, a protective circuit into which an overcharge or overdischarge preventing mechanism is embedded is provided to a charger or is separately connected to a charger.

As the can or the lead plate, an electrically conductive metal or alloy can be used. For example, a metal such as iron, nickel, titanium, chromium, molybdenum, copper or aluminum or an alloy thereof is preferably used.

As a welding method of a cap, a can, a sheet, or a lead plate, a well-known method (for example, DC or AC electric welding, laser welding, or ultrasonic welding) can be used. As a sealing agent for sealing the opening, a well-known compound of the related art such as asphalt or a mixture can be used.

[Use of Non-Aqueous Electrolytic Solution Secondary Battery]

The non-aqueous electrolytic solution secondary battery according to the present invention is superior in cycle characteristics and is applied to various uses. Here, the terms will be defined as follows. When it is necessary to distinguish “lithium ion secondary battery” and “lithium metal secondary battery” from each other, “lithium ion secondary battery” refers to a secondary battery in which the storage and release of lithium is used in a charging-discharging reaction, and “lithium metal secondary battery” refers to a secondary battery in which the deposition and dissolution of lithium is used in a charging-discharging reaction. “Lithium secondary battery” is a collective term for the lithium ion secondary battery and the lithium metal secondary battery.

The application embodiment of the non-aqueous electrolytic solution secondary battery is not particularly limited, and examples of an electronic apparatus to which the non-aqueous electrolytic solution secondary battery is applied include a laptop computer, a pen-input PC, a mobile PC, an electronic book player, a mobile phone, a cord-less phone system, a pager, a handy terminal, a portable fax, a portable copying machine, a portable printer, a headphone stereo set, a video camera, a liquid crystal television, a handy cleaner, a portable CD player, a mini disc player, an electric shaver, a transceiver, an electronic organizer, an electronic calculator, a portable tape recorder, a radio player, a backup power supply and a memory card. In addition, examples of an electronic apparatus for consumer use include an automobile, an electromotive vehicle, a motor, a lighting device, a toy, a game device, a load conditioner, a timepiece, a strobe, a camera, and a medical device (for example, a pacemaker, a hearing aid, or a shoulder massager). Further, the non-aqueous electrolytic solution secondary battery can be used as various batteries for use in military or aerospace applications. In addition, the non-aqueous electrolytic solution secondary battery can be used in combination with a solar battery.

A metal ion which is used for transporting an electron in the secondary battery is not particularly limited, and it is preferable that a metal ion in Group I or Group II in the periodic table is used. Among these, for example, a lithium ion, a sodium ion, a magnesium ion, a calcium ion, or an aluminum ion is preferably used. Regarding a secondary battery using a lithium ion, general technical features can refer to various documents and publications such as Patent Documents which are described above at the beginning of this specification. Regarding a secondary battery using a sodium ion, for example, general technical features can refer to Journal of Electrochemical Society; and Electrochemical Science and Technology United States, 1980, Vol. 127, pp. 2097 to 2099. Regarding a secondary battery using a magnesium ion, for example, general technical features can refer to Nature pp. 407, 724 to 727 (2000). Regarding a secondary battery using a calcium ion, for example, general technical features can refer to J. Electrochem. Soc. Vol. 138, 3536 (1991). It is preferable that the present invention is applied to a lithium ion secondary battery because the lithium ion secondary battery is widely used. Even when the present invention is applied to other batteries, the desired effects can be exhibited, and the present invention is not limited to a lithium ion secondary battery.

### EXAMPLES

Hereinafter, examples of the present invention will be described, but the present invention is not limited to these examples.

### Example 1

(Preparation of Electrolytic Solution)

Components shown in Table 1 below were mixed to prepare an aprotic solvent, and a lithium salt was added thereto. A flame retardant shown in the table was added to the solution to prepare a non-aqueous electrolytic solution.

(Preparation of 2032-Type Coin Battery)

A positive electrode was prepared using an electrode mixture including: 85 mass % of lithium cobalt oxide (LiCoO₂) as an active material; 7.5 mass % of carbon black as a conductive auxiliary agent; and 7.5 mass % of PVDF as a binder. A negative electrode was prepared using an electrode mixture including: 85 mass % of graphite as an active material; 7.5 mass % of carbon black as a conductive auxiliary agent; and 7.5 mass % of PVDF as a binder. In order to prepare a separator (Test 101), a film of polyethylene (low-melting-point resin) having a thickness of 25 μm was coated with an aramid (heat-resistant resin). After being coated with the heat-resistant resin, the thickness of the separator was 40 μm. Using the positive and negative electrodes and the separator, a 2032-type coin battery was prepared for each electrolytic solution for a test and was evaluated for the following items of battery characteristics. The results are shown in Table 1.

A separator using inorganic particles was prepared as follows. A polyethylene porous film (thickness: 20 μm) was coated with an alumina slurry (in which 60 g of tetraethoxysilane, 15 g of methylethoxysilane, and 700 g of alumina fine particles were dispersed in 100g of 5% hydrochloric acid aqueous solution) using a roller. After the coating, the thickness of the porous film was about 40 μm. A sample of Test 102 was prepared as described above. In a similar way, a sample of another test using inorganic particles was prepared.

<Flame Retardancy>

Referring to the UL-94 HB (horizontal burning) test, an evaluation was performed in the following test system. Each of various separators was cut into a width of 13 mm and a length of 110 mm, and 1.5 ml of the prepared electrolytic solution was uniformly dropped on a separator. After the electrolytic solution was sufficiently impregnated into the separator, the remaining electrolytic solution was wiped off, and the separator was horizontally suspended. The separator was ignited for 3 seconds at a position where a tip end of the separator was in contact with flame at a distance of 5 cm from a tip end of a butane gas burner in which the entire flame length was adjusted to 2 cm. Next, after being removed from the flame, the condition of the separator was evaluated.
AA . . . A level where the shape of the separator was maintained; and the separator was not burned or the flame was removed
B . . . A level where the shape of the separator was maintained, and a combustion preventing effect was observed; however, the separator was burned, and the flame was not removed
C . . . A level where the separator was deformed or a combustion preventing effect was not observed

<Cycle Characteristics>

In a thermostatic chamber at 30° C., the 2032-type battery prepared using the above-described method was charged to a battery voltage of 4.3 V at a constant current of 2.0 mA at 1 C. Next, the battery was charged to a current value of 0.12 mA at a constant voltage of 4.3 V or was charged for two hours. Next, the battery was discharged to a battery voltage of 2.7 V at a constant current of 2.0 mA at 1 C. The above-described processes were set as one cycle. This cycle was repeated, and the number of cycles was measured until the discharge capacity (mAh) was 70% or lower of the discharge capacity of the first cycle.
AA: 100 cycles or more
A: 90 cycles or more and less than 100 cycles
B: 70 cycles or more and less than 90 cycles
C: less than 60 cycles

<Wettability>

Evaluation of Wettability

The contact angle of each of the prepared electrolytic solutions with the prepared separator was measured using a contact angle meter Drop Master 700 (manufactured by Kyowa Interface Science Co., Ltd.). The evaluation criteria are as follows.
A: When the contact angle was less than a contact angle value of an electrolytic solution not containing a flame retardant with a separator composed of a material of B1
B: When the contact angles were equal to each other
C: When the contact angle was greater than the contact angle value of an electrolytic solution not containing a flame retardant with a separator composed of a material of B1

<Tg>

Tg was identified by the following measurement.

Regarding each of various materials constituting a separator, the thermal behavior thereof was observed using a high-sensitivity differential scanning calorimeter X-DSC 7000 (manufactured by SII Nanotechnology Inc.). At this time, the derivative of the DSC curve relative to the temperature was obtained, and a temperature of an upwardly convex curve was obtained as Tg (glass transition temperature).

In the separator, the substrate and the heat-resistant material coating the surface of the substrate were used as described below.

TABLE A

| | Heat-Resistant Material A | | Number Average | |
|---|---|---|---|---|
| No. | Non-Heat-Resistant Resin B | Tg | Molecular Weight | Details |
| A1 | Aramid Resin | 250° C. | 50,000 | Manufactured by Sigma-Aldrich Co., LLC, |
| | (Polyamide Resin) | | | Resin Prepared by Fiberizing |
| | | | | Poly[N,N′-(1,3-Phenylene)Isophthalamide] |
| | | | | (Product No. 446521) |
| A2 | Silica Fine Particles | — | | Manufactured by Sigma-Aldrich Co., LLC, |
| | | | | Fumed Silica (Trade Name), Primary Particle |
| | | | | Size: 7 μm |
| A3 | Alumina Fine Particles | — | | Manufactured by Sigma-Aldrich Co., LLC |
| | | | | (Product No. 265497), Particle Size: 10 μm |
| A4 | PET Resin Fiber | 120° C. | 100,000 | Manufactured by Sigma-Aldrich Co., LLC, |
| | | (Melting | | (Product No. 429252), Non-Woven Fabric |
| | | Point: | | (Wet) Prepared by Fiberizing |
| | | 270° C.) | | |
| A5 | Polymethylpentene Fiber | 160° C. | 50,000 | Manufactured by Sigma-Aldrich Co., LLC, |
| | | (Melting | | (Product No. 190993), Non-Woven Fabric |
| | | Point: | | (Wet) Prepared by Fiberizing Poly(4-Methyl-1-Pentene) |
| | | 260° C.) | | |
| A6 | Polyimide Fiber | 250° C. | 50,000 | Manufactured by Sigma-Aldrich Co., LLC, |
| | | | | Non-Woven Fabric (Wet) Prepared By |
| | | | | Fiberizing Poly(Pyromellitic Dianhydride-3,6- |
| | | | | Diaminoacridine (Product No. 56667) |
| A7 | Polyacrylonitrile Fiber | 110° C. | 300,000 | Manufactured by Sigma-Aldrich Co., LLC, |
| | | | | (Product No. 181315), Non-Woven Fabric |
| | | | | (Wet) Prepared by Fiberizing |
| A8 | PP/PTFE/PVDF Copolymer | 150° C. | 50,000 to | Refer to Example 1 of JP2001-52676A |
| | | | 100,000 | |
| B1 | PE Resin | 60° C. | 30,000 | Manufactured by Sigma-Aldrich Co., LLC, |
| | | (Melting | | Resin Prepared by Mixing and Dispersing |
| | | Point: | | Polyethylene (Mw: 125,000), Dioctyl Phthalate, |
| | | 130° C.) | | and Powder Silica Gel Porosity (40%), |
| | | | | Average Particle Size: About 0.2 μm |
| B2 | PP/PE Resin | 80° C. | PP: 50,000 | Resin Prepared By Same Procedure as That of B1 After |
| | | (Melting | PE: 30,000 | Kneading PP (Manufactured by Sigma-Aldrich Co., LLC, |
| | | Point: | | Polypropylene (Mw: 190,000), 5%) and PE |
| | | 160° C.) | | (Manufactured by Sigma-Aldrich Co., LLC, |
| | | | | Polyethylene (Mw: 125,000), 95%) with Stabilizer |
| | | | | Porosity (45%), Average Particle Size: About 0.3 μm |

TABLE 1

| | | | Separator | | | | | | |
|---|---|---|---|---|---|---|---|---|---|
| | | Addition | Coating Layer | Substrate | | | | | Cycle |
| | Flame | Amount | Heat-Resistant | Non-Heat-Resistant | Negative | Positive | Flame | | Characteristics |
| No. | Retardant | (mass %) | Material | Resin | Electrode | Electrode | Retardancy | Wettability | (4.3 V) |
| 101 | 1-4 | 5 | A1 | B1 | Gr | LCO | AA | A | AA |
| 102 | 1-4 | 7 | A3 | B1 | Gr | LCO | AA | A | AA |
| 103 | 1-70 | 7 | A4 | B1 | Gr | LCO | AA | A | A |
| 104 | 1-70 | 9 | A4 | B1 | Gr | LCO | AA | A | A |
| 105 | 1-63 | 10 | A4 | B1 | Gr | LCO | AA | A | AA |
| 106 | 1-63 | 10 | A5 | B1 | Gr | LCO | AA | A | A |
| 107 | 1-36 | 7 | A6 | B1 | Gr | LCO | AA | A | A |
| 108 | 1-36 | 9 | A7 | B1 | Gr | LCO | AA | A | A |
| 109 | 1-1 | 9 | A1 | B1 | Gr | LCO | AA | A | AA |
| 110 | 1-2 | 7 | A2 | B1 | Gr | LCO | AA | A | AA |
| 111 | 1-2 | 9 | A1 | B1 | Gr | LCO | AA | A | A |
| 112 | 1-4 | 7 | A8 | B2 | Gr | LCO | AA | A | A |
| C11 | — | — | A1 | B1 | Gr | LCO | B | C | B |
| C12 | — | — | A2 | B2 | Gr | LCO | B | C | B |
| C13 | 1-4 | 7 | — | B1 | Gr | LCO | C | B | A |
| C14 | P-1 | 17 | A1 | B1 | Gr | LCO | C | B | C |
| C15 | P-2 | 17 | A2 | B2 | Gr | LCO | C | B | C |
| C16 | P-3 | 17 | A3 | B1 | Gr | LCO | B | B | C |

Gr: Graphite
LCO: LiCoO₂

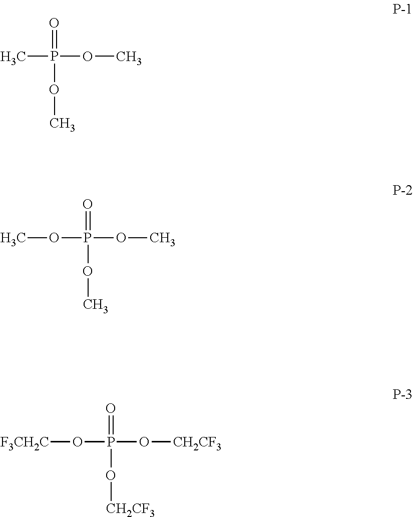

It can be seen from the above results that a non-aqueous electrolytic solution secondary battery according to the present invention can further improve flame retardancy while securing battery performance by using an electrolytic solution containing a specific flame retardant in combination with a separator having a specific heat-resistant coating structure.

The present invention has been described using the embodiments. However, unless specified otherwise, any of the details of the above description is not intended to limit the present invention and can be construed in a broad sense within a range not departing from the concept and scope of the present invention disclosed in the accompanying claims.

What is claimed is:

1. A non-aqueous electrolytic solution secondary battery comprising:
a positive electrode;
a negative electrode;
a separator disposed between the positive electrode and the negative electrode; and
an electrolytic solution that is in contact with the positive electrode and the negative electrode through the separator,
wherein the electrolytic solution contains an electrolyte, a phosphazene compound, and an aprotic solvent,
the separator is a complex that is composed of a substrate containing a non-heat-resistant resin and a heat-resistant material coating the substrate, and
the phosphazene compound is represented by the following formula (1); 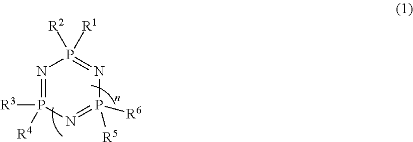
in the formula (1), R¹ to R⁶ each independently represents a monovalent substituent; n represents an integer of 1 or more; and in the case where n is 2 or more, R⁵ and R⁶ may be different from each other,
at least one of R¹ to R⁶ is —NR^{A}R^{B}, —N═R^{C}, or an azide group: R^{A} and R^{B} each independently represents a hydrogen atom, an alkyl group, an aryl group, an alkenyl group, an alkynyl group, a heterocyclic group, a cyano group, a silyl group, or a substituent represented by the following formula (1A), (1B), (1C) or (1D), 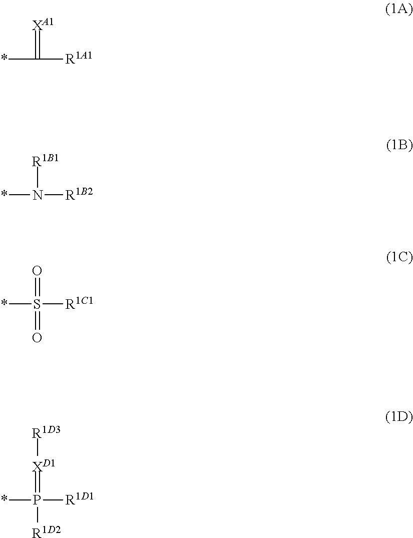
in the formula, R^{1A1}, R^{1C1}, R^{1D1}, and R^{1D2} each independently represents an alkyl group, an alkoxy group, an aryl group, an aryloxy group, a halogen atom, or an amino group,
R^{1B1} and R^{1B2} each independently represents a hydrogen atom, an alkyl group, an aryl group, an alkoxycarbonyl group, an aryloxycarbonyl group, an alkylsulfonyl group, an arylsulfonyl group, a silyl group, or a phosphonyl group,
X^{A1} represents an oxygen atom or a sulfur atom,
X^{D1} represents an oxygen atom, a sulfur atom, or a nitrogen atom: in the case where X^{D1} represents an oxygen atom or a sulfur atom, R^{1D3} is not present: in the case where X^{D1} represents a nitrogen atom, R^{1D3} represents an alkyl group, an aryl group, a silyl group, or a phosphonyl group,
Rc represents a substituent represented by any one of the following formulae (C1) to (C6), 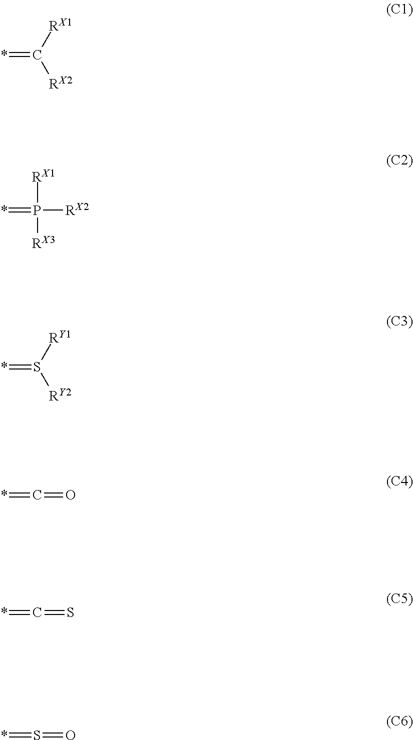
in the formula, R^{X1}, R^{X2}, and R^{X3} each independently represents an alkyl group, an aryl group, an alkoxy group, an aryloxy group, an alkylthio group, an arylthio group, a heterocyclic group, a halogen atom, or a silyl group,
R^{Y1} and R^{Y2} each independently represent a halogen atom.

2. The non-aqueous electrolytic solution secondary battery according to claim 1,
wherein the substrate is a resin microporous film.

3. The non-aqueous electrolytic solution secondary battery according to claim 1,
wherein a heat-resistant resin is used as the heat-resistant material, and
a difference ΔTg=Tg2−Tg1 between a glass transition point Tg1 of a resin constituting the substrate and a glass transition point Tg2 of the heat-resistant resin is 30° C. to 250° C.

4. The non-aqueous electrolytic solution secondary battery according to claim 3,
wherein the heat-resistant resin is selected from a polyamide resin, a polyimide resin, polyacrylonitrile, polyethylene terephthalate, polyfluoroethylene, and polymethylpentene.

5. The non-aqueous electrolytic solution secondary battery according to claim 1,
wherein the heat-resistant material is fibrous or particulate.

6. The non-aqueous electrolytic solution secondary battery according to claim 1,
wherein alumina or silica is used as the heat-resistant material.

7. The non-aqueous electrolytic solution secondary battery according to claim 1,
wherein the non-heat-resistant resin is polyethylene or polypropylene.

8. The non-aqueous electrolytic solution secondary battery according to claim 1,
wherein the substrate of the separator is a microporous film containing polyethylene or polypropylene, and
the heat-resistant material coating the substrate is selected from a polyamide resin, a polyimide resin, polyacrylonitrile, polyethylene terephthalate, and polymethylpentene.

9. The non-aqueous electrolytic solution secondary battery according to claim 1,
wherein the positive electrode is an electrode containing manganese.

10. The non-aqueous electrolytic solution secondary battery according to claim 1,
wherein the substrate of the separator has a thickness of 2 μm to 50 μm.

11. The non-aqueous electrolytic solution secondary battery according to claim 1,
wherein a coating layer formed by using the heat-resistant material has a thickness of 2 μm to 30 μm.
